(19) United States
(12) Patent Application Publication
(10) Pub. No.: US 2015/0008678 A1
(43) Pub. Date: Jan. 8, 2015

(54) AIRBORNE WIND ENERGY CONVERSION SYSTEM WITH ENDLESS BELT AND RELATED SYSTEMS AND METHODS

(71) Applicant: Leonid Goldstein, Austin, TX (US)

(72) Inventor: Leonid Goldstein, Austin, TX (US)

(21) Appl. No.: 14/494,340

(22) Filed: Sep. 23, 2014

Related U.S. Application Data
(63) Continuation of application No. PCT/US13/30314, filed on Mar. 12, 2013.
(60) Provisional application No. 61/621,083, filed on Apr. 6, 2012.
(60) Provisional application No. 61/657,026, filed on Jun. 8, 2012.
(60) Provisional application No. 61/662,476, filed on Jun. 21, 2012.
(60) Provisional application No. 61/671,242, filed on Jul. 13, 2012.

(51) Int. Cl. F03D 1/06; F03D 9/00

(52) U.S. Cl. CPC F03D 1/065; F03D 9/002
USPC 290/55

(57) ABSTRACT

Airborne wind energy conversion system with a propeller (4102) and a ground generator (4107), comprising a cross wind flying wing (4101), in which mechanical energy is transferred from the wing to the ground generator using an endless belt (4105). Another airborne wind energy conversion system, comprising a rotor, formed by freely moving wings, transferring its mechanical power to a ground based generator via a belt. The system can utilize a ribbon, connecting the wings. The belt can move continuously or reciprocally. The rotor can be axial flow, cross flow, diagonal flow or 3D flow. Related AWECS raising and landing methods are disclosed.

### CROSS REFERENCE TO RELATED APPLICATIONS

This application is a continuation of PCT Application No. PCT/US13/30314, filed 12 Mar. 2013, which claims the benefit of U.S. Provisional Applications No. 61/621,083, filed 6 Apr. 2012, No. 61/657,026, filed 8 Jun. 2012, No. 61/662,476, filed 21 Jun. 2012, and No. 61/671,242, filed 13 Jul. 2012 by the same inventor as herein, the entire disclosure of which is incorporated herein by reference.

### BACKGROUND OF THE INVENTION

This invention is generally directed to airborne wind energy conversion systems and methods. The classical work in the airborne wind energy conversion systems (AWECS) is the article by Miles L. Loyd “Crosswind Kite Power” (1979), in which the author disclosed a wind energy harvesting device, comprising a tethered wing, flying cross wind and harvesting wind energy, and transferring harvested energy to a ground based generator via motion of the tether. Crosswind motion of a wing is much more efficient, than downwind motion, allowing the wing to fly many times speed of the wind and harvest energy from an area, many times larger than the area of the wing. The article has also offered two ways of converting harvested mechanical energy into electrical energy. In one of them, the electrical generator is on the ground and the tether is reeling out, transferring motion to the rotor of the generator. Systems, implementing this method are discussed in the U.S. Pat. Nos. 7,504,741 & 7,546,813 by Wrage et al, U.S. Pat. No. 8,080,889 by Ippolito et al, U.S. Pat. No. 6,523,781 by Ragner. Velocity of the lengthwise motion of the tether must be well below velocity of the wing. In such conditions, the tether is subject to the very high force, requiring thick tethers and creating very large torque in the ground equipment for useful power, thus rendering the whole system uneconomical.

In another method, the generator is airborne and its rotor is coaxial with the propeller, driven by relative air flow. This method is discussed in the U.S. Pat. No. 3,987,987 by Payne et al., U.S. Pat. No. 8,109,711 by Blumer et al. Among shortcomings of this method are large weight of the generator, carried onboard, large weight and limited flexibility of the tether, which is tasked with conducting electrical power from the generator to the ground.

The systems with downwind wing motion or with drag based (i.e., non airfoil) airborne members are also worth mentioning. One such system is discussed in the U.S. Pat. No. 6,072,245 by Ockels. Aside of the shortcoming of the downwind wing motion, it forces the wings to approach the ground and uses a complex apparatus to prevent collision between the wings and the ground mechanisms.

This invention is directed to solving these shortcomings and providing a cost efficient AWECS.

### SUMMARY OF THE INVENTION

This invention is generally directed to airborne wind energy conversion systems and methods.

One embodiment of the invention is a wind energy conversion system, comprising: at least one airborne wing, moving mostly cross wind; an electrical generator on the ground; a rotational member on the ground, rotationally coupled to the rotor of the electrical generator; an endless belt coupled to the wing and engaging the rotational member.

The system can further comprise an electronic control system adapted to control flight of the wing. The system can also comprise a tether, attaching the airborne wing to the ground (directly or indirectly). The airborne wing can carry a propeller and an airborne rotational member, rotationally coupled to that propeller; the endless belt engages the airborne rotational member in addition the ground rotational member. Both the airborne and the ground rotational members can be pulleys or (if using a perforated belt) sprockets. Alternatively, the system can comprise two or more airborne wings, moving in substantially elliptical path. The multiple airborne wings can further comprising a device temporary attaching the wing to the belt. The airborne wings can be coupled to one another by means additional to the belt, such as cables or a ribbon.

Another embodiment of the invention is a method of generating power from the wind, comprising steps of: providing an electrical generator on the ground; capturing wind energy with an airborne wing controlled to move mostly cross wind faster than wind; and transferring the captured wind energy to the power generator by motion of an endless belt. This method can further comprise steps of: using a propeller on the airborne wing; using a relative air flow to rotate the propeller; converting rotation of the propeller into motion of the endless belt. Alternatively, at least two wings can provided and the motion of the wings along closed trajectory can be converted into motion of the endless belt.

Another embodiment of the invention is a method of wind power conversion, comprising steps of: providing a power converting device on the ground; capturing wind energy with an airborne wing controlled to move mostly cross wind faster than wind; and transferring the captured wind energy to the power generator by motion of an endless belt. The power converting device can be an electrical generator, an air compressor, a water pump or other.

Further, the invention teaches the following mechanical principles. These principles are designed for erecting structures, that are used in the presence of the wind, including wind energy converting systems and ship propulsion systems on the wind energy. The basic set of principles:

1) loading structural members with only two types of forces (besides weight):
aerodynamic lift, acting on a moving airfoil
tension of cables or belts
   2) dynamic stability of the structure, achieved by using a computer based automatic control system.

Each airfoil should be controlled in at least three axis: pitch, roll and yaw. Additional controls, changing airfoil profile to increase lift or drag, are welcome. Construction of airfoils and their control surfaces is borrowed from planes, gliders, kites, ship sails (rather than from wind turbines.) An additional principle, applicable to wind energy conversion systems:

3) mechanical power transfer from airfoils to a rotor of a generator on the ground, or water surface, by a fast moving cable or belt; “fast” means with the speed, exceeding speed of the wind, acting on the airfoils. An extended set of principles allows loading members with five types of forces; the additional types of forces are:
force of inertia of a moving member
lift of lighter than air body
wind pressure, acting on static members; this pressure can be of either of the lift or the drag type.

Thus, bending moment and compression forces are eliminated from the large construction members. In some designs, the moving airfoils can become detached from the rest of construction cyclically for short periods of time. This allows for a very light, relatively inexpensive and safe (for unmanned operation over unpopulated, but occasionally visited, land or water) airborne construction. In the wind energy systems, it is matched by a similarly inexpensive ground generator, not requiring a gearbox in most cases.

Another embodiment of the invention is a method of converting wind energy into electric energy, comprising steps of: providing at least two wings, each of the wings comprising at least control actuators for controlling its pitch, yaw and roll; providing an electronic control system, having at least one microprocessor, at least one sensor and at least the control actuators; providing an electrical generator, installed on the ground; controlling the wings to move cyclically in a limited space in the air under power of wind; mechanically transferring energy of the wings to the electrical generator.

Another embodiment of the invention is a device for converting wind energy into electric energy, comprising: at least two wings, placed in the air and moving under power of wind faster than the wind; each aforementioned wing comprising at least control actuators for controlling its pitch, yaw and roll; an electronic control system, comprising at least one microprocessor, at least one sensor and at least said control actuators; an electrical generator, installed on the ground; a pulley, rotationally connected to the rotor of the electrical generator; a belt, one end of which is wrapped around the pulley; wherein movement of the wings brings in motion the belt.

Another embodiment of the invention is a device for converting wind energy into electric energy, comprising: at least two wings, placed in the air and moving under power of wind faster than wind; each aforementioned wing comprising at least control actuators for controlling its pitch, yaw and roll; an electronic control system, comprising at least one microprocessor, at least one sensor and at least said control actuators; an electrical generator, installed on the ground; one of the following: a) a closed loop belt, transferring motion of the wings to the rotor of the generator by its continuous motion; b) a closed loop belt, transferring motion of the wings to the rotor of the generator by belt's reciprocal motion.

Another embodiment of the invention is a device for converting wind energy into electric energy, comprising: a wing, placed in the air and moving under power of wind faster than wind; the wing comprising at least control actuators for controlling its pitch, yaw and roll; an electronic control system, comprising at least one microprocessor, at least one sensor and at least said control actuators; an electrical generator, installed on the ground; a tether, attaching the wing to the ground; a belt or a cable, other than the tether, transferring motion of said wing to said rotor of said generator.

Another embodiment of the invention is a method for raising an airborne wind energy conversion system to the air, comprising steps of: using a helicopter or a balloon to raise wings of the airborne wind energy conversion system to the air; holding the wings in such way as not to hinder their working motion; letting the wings go, after they started their normal motion;

Another embodiment of the invention is a method for raising airborne wind energy conversion system to the air, comprising steps of: using a helicopter or a balloon to raise wings of the airborne wind energy conversion system to the air; in the air, letting the wings go; after wings acquire pre-defined velocity, using their control surfaces to maneuver them into the position and attitude, necessary to start normal working motion of the system; starting normal working motion of the system. Another embodiment of the invention is a method for raising airborne wind energy conversion system to the air, comprising steps of: attaching expendable lighter than air balloons to wings of the airborne wind energy conversion system; letting the wings to rise in the air and start moving; letting the balloons go.

Another embodiment of the invention is a method of bringing an airborne wind energy conversion system to the ground, comprising steps of: attaching folded balloons and containers with compressed lighter than air gas to wings of the airborne wind energy conversion system; issuing a command to bring the airborne wind energy conversion system to the ground; inflating said balloons with lighter than air gas from said containers upon receiving the command.

Another embodiment of the invention is a method for bringing an airborne wind energy conversion system to the ground, comprising steps of: attaching folded parachutes to wings and/or cables of the airborne wind energy conversion system; issuing a command to bring the airborne wind energy conversion system to the ground; opening the parachutes on receiving the command.

Another embodiment of the invention is a method of enhancing safety of an airborne wind energy conversion system, comprising steps of: attaching at least one folded parachute to a wing and/or a cable of the airborne wind energy conversion system; detecting emergency conditions, including one of the following: a) loss of control of the wind energy conversion system, b) tear down of a cable or a belt, c) breakdown of a wing, d) detachment of a wing from a cable, e) an air collision; opening the parachute on detecting the emergency conditions. The parachute allows the wing or the cable to decelerate, decreases energy, with which it hits ground, and lets any humans, who might be hit to escape. The latter function may be enhanced by using warning sound or voice in such emergency situation.

Another embodiment of the invention is a device for creating a desirable force in desirable direction in presence of at least threshold wind, comprising: an anti-twist device, having a first end and a second end, combined in such way that rotation of the first end is allowed but not transferred to the second end; two or more wings of the same dimensions, connected to the first end of the anti-twist device by cables of substantially equal length larger than span of wing; each wing comprising at least control actuators for controlling its pitch, yaw and roll; an electronic control system, comprising at least one microprocessor, at least one sensor and at least said control actuators; the wings placed in the wind and controlled to move under power of wind in substantially same circular trajectory with angle of attack below stall angle in such way that imaginary vector, starting in the anti-twist device and perpendicular to the plane of said wings' circle points to said desirable direction.

Another embodiment of the invention is a method of creating a constant force in desirable direction in presence of at least threshold wind, comprising steps of: providing an anti-twist device, having a first end and a second end, combined in such way that rotation of the first end is allowed but not transferred to the second end; providing two or more wings of the same dimensions, connected to the first end of the anti-twist device by cables of substantially equal length larger than the span of the wing; each wing comprising at least control actuators for controlling its pitch, yaw and roll; providing an electronic control system, comprising at least one microprocessor, at least one sensor and at least said control actuators; placing the wings in the wind and controlling them to move in a circle with an axis, parallel to desirable direction of force; controlling the pitch of the wings to create total lift, equal to the desirable lift value, while their centrifugal forces compensate each other;

Another embodiment of the invention is a method of operating wings of airborne wind energy conversion device, comprising steps of: placing at least two wings in the air; each aforementioned wing comprising at least control actuators for controlling its pitch, yaw and roll; providing an electronic control system, comprising at least one microprocessor, at least one sensor and at least said control actuators; providing an electrical generator, installed on the ground, having a rotor and a stator; controlling wings to move in a closed trajectory around a common center in one of the following ways: a) in a plane; b) in a three dimensional curve.

Another embodiment of the invention is a method of operating wings of airborne wind energy conversion device, in which energy of wings motion is transferred to a ground electric generator using a perforated belt, rotating a toothed pulley or a sprocket on the ground.

Another embodiment of the invention is a device for converting wind energy into electrical energy, comprising: at least one wing, placed in the air and staying in the air and moving under force of wind; a propeller, attached to the wing, and rotated by incoming air stream; a first pulley, attached to the wing and rotationally connected to said propeller; an electrical generator on the ground, having a rotor and a stator; a second pulley on the ground, rotationally connected to the rotor of the generator; a belt, connecting the first pulley and the second pulley; an electronic control system, comprising at least one microprocessor, at least one sensor and at least one actuator.

There can be an additional yawing system on the ground, rotating a nacelle with the generator in response to changes in the wind. Alternatively, the axis of the second pulley is substantially vertical, and guiding rollers and/or guiding rails are provided to guide the belt toward said second pulley substantially horizontally.

Another embodiment of the invention is a device for converting wind energy into electrical energy, comprising: at least one wing, placed in the air and moving under power of wing; an electrical generator, having a rotor and a stator; a rotational element, such as a drum or a pulley, connecting to the rotor of the electrical generator and capable of rotating said rotor; at least one cable or belt, attached to the wing and winding about or wrapped around said drum or said pulley; the cable or belt moves with the speed of at least twice the speed of wind in the direction of its own stretch near the drum or the pulley; an electronic control system, comprising at least one microprocessor, at least one sensor and at least one actuator.

In some embodiments, control of only two out of three—pitch, yaw roll—is sufficient. In some embodiments, a device, converting mechanical energy into another storable energy can be used instead of electric generator. Storable energy includes chemical, thermodynamic, thermal and potential energy.

The description uses prior patent applications by the inventor:

### PCT/US12/66331

### PCT/US12/67143

### PCT/US12/71581

The description additionally references the following publications: The article “Crosswind Kite Power” by Loyd (Energy journal, 1980; 4:106-11)

The article “KiteGen project: control as key technology for a quantum leap in wind energy generators” by Canale et al (Proc. of American Control Conference, New York 2007).

All referenced patents, patent applications and other publications are incorporated herein by reference, except that in case of any conflicting term definitions or meanings the meaning or the definition of the term from this description prevails.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

The accompanying drawings illustrate the invention. The illustrations omit details not necessary for understanding of the invention, or obvious to one skilled in the art, and show parts out of proportion for clarity. In such drawings:

FIG. 1 is a perspective-schematic view of AWECS according to one embodiment of the invention.

FIG. 2A is a schematic view of that embodiment, perpendicular to the main motion plane.

FIG. 2B is a schematic side view of that embodiment, perpendicular to the wind and previous view.

FIG. 2C is a schematic top angled view of that embodiment

FIG. 3 is a schematic depiction of forces, acting on an AWECS wing.

FIG. 4 is a sectional view of a traction device and a belt in time of approach and after the contact.

FIG. 5 is a perspective-schematic view of a rigid wing and its control surfaces.

FIG. 6 is a perspective view of a soft wing and its control lines in that embodiment.

FIG. 7 is a view of two of possible wing planforms.

FIG. 8 is a schematic-perspective view of an AWECS with variable effective attachment point.

FIG. 9 is a schematic-perspective view of the AWECS with variable effective attachment point and multiple belt wraps.

FIG. 10 is a schematic-perspective view of an AWECS in a form of an axial flow rotor on a ribbon.

FIG. 11 is a schematic side view of the AWECS in a form of an axial flow rotor on a ribbon.

FIG. 12 is a profile view of wing attachment to the ribbon.

FIG. 13A is a sectional view of the ribbon and the cable.

FIG. 13B is a side view of the ribbon and the cable.

FIG. 14A is a sectional view of the ribbon with winglets and the cable.

FIG. 14B is a side view of the ribbon with winglets and the cable.

FIG. 15 is a side view of an AWECS with RDS pulleys.

FIG. 16 is a schematic view of a control system.

FIG. 17 is a perspective view of an AWECS with a cross flow rotor on a ribbon.

FIG. 18 is a schematic view, perpendicular to the main motion plane, of the AWECS with cross flow rotor and a cambered wing.

FIG. 19 is a schematic view, perpendicular to the main motion plane, of the AWECS with cross flow rotor and a non-cambered (symmetrical) wing.

FIG. 20A is a perspective view of another form of the rigid wing.

FIG. 20B is a front view of that form of the rigid wing.

FIG. 21 is a perspective view of one form of a soft wing.

FIG. 22 is a perspective-schematic view of an AWECS with a horizontal cross flow rotor on a ribbon.

FIG. 23 is a perspective view of an AWECS with a cross flow rotor on a ribbon with balloon support.

FIG. 24 is a perspective view of an AWECS with an axial flow rotor on a ribbon with balloon support.

FIG. 25 is a perspective-schematic view of an AWECS with a different axial flow rotor on a ribbon with balloon support.

FIG. 26 is a perspective-schematic view of an AWECS with a diagonal flow rotor on a ribbon with balloon support.

FIG. 27 is a schematic view of wings' positions.

FIG. 28 is a perspective-schematic view of an AWECS with a sky anchor in a form of rotational dynamic sail.

FIG. 29 is a perspective-schematic view of an AWECS with a cross flow rotor on a ribbon with a tether, horizontal.

FIG. 30 is a perspective-schematic view of an AWECS with a cross flow rotor on a ribbon with a tether and a crossing device.

FIG. 31 is a side view of the crossing device.

FIG. 32 is a view perpendicular to the motion plane of an AWECS with a cross flow rotor on a ribbon with a tether and a crossing device.

FIG. 33 is a perspective-schematic view of one more form of a rigid wing.

FIG. 34 is a front view of another form of a wing, comprising two smaller wings.

FIG. 35 is a perspective-schematic view of an AWECS with a cross flow rotor on a ribbon with a tether, vertical.

FIG. 36 is a perspective-schematic view of an AWECS with a cross flow rotor and reciprocal motion of wings.

FIG. 37 is a scheme of the wing pitching in the AWECS with reciprocal motion.

FIG. 38 is a schematic view of the AWECS with reciprocal motion, perpendicular to the main motion plane.

FIG. 39 is a scheme of motion in the main motion plane.

FIG. 40 is a scheme of multiple wings' pitching.

FIG. 41 is a perspective view of an AWECS with an airborne prop and a ground generator, connected by a belt.

FIG. 42 is a scheme of a possible wing motion trajectory by a wing with a prop.

FIG. 43 is a close view of the wing with a prop.

FIG. 44A is a perspective view of details of the ground station, interacting with the wing with a prop.

FIG. 44B is a top view of details of the ground station, interacting with the wing with a prop.

FIG. 45 is a perspective view of a parafoil wing with a prop.

### GLOSSARY

Center of a wing—a point on the wing, in which total of aerodynamic forces create zero momentum.

Terms pitch, roll and yaw and names of wing axis are used in the same sense as in the aircraft engineering.

Ground (as in “a generator on the ground”) includes both land and water surface and positions slightly elevated above the surface or slightly below the surface, there is an attachment to the land or floating in the water or attachment to the water body bottom.

Direction of the wind means direction to which the wind blows, i.e. direction of the vector, describing the wind.

AWECS—airborne wind energy conversion system—is a wind energy conversion system, in which at least the wings are airborne.

Fₐ—total aerodynamic force, sum of lift and drag

### DETAILED DESCRIPTION OF THE PREFERRED EMBODIMENTS

### Embodiments AA

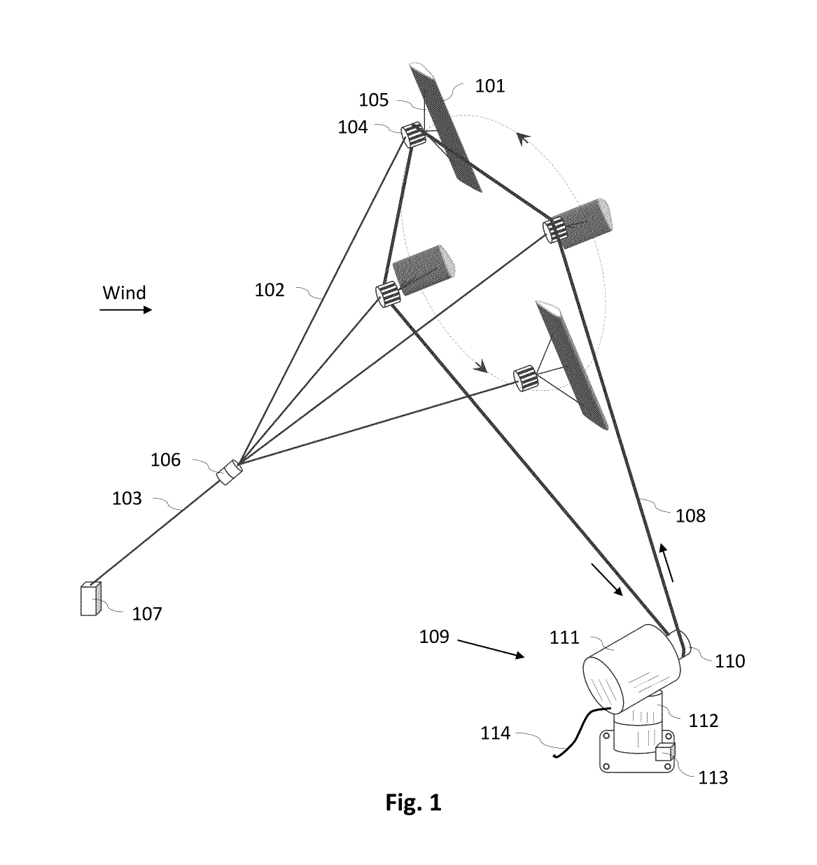

FIG. 1 shows a perspective view of one embodiment of the invention. Two or more wings 101 are placed in the air and are flying cross wind with a speed, significantly exceeding speed of the wind. FIG. 1 shows a variant of the embodiment with four wings. The trajectory of all the centers of wings 101 is the same and it is a closed curve. Each wing 101 carries a traction device 104, which is described below. Trajectory of traction devices 104 lies in a substantially one plane, or close to one plane. We will call it plane P. Traction device 104 can be attached to wing 101 directly and rigidly near wing's center or via suspension cables 105. Each wing is held by a wing cable 102, which can be attached to a traction device 104. The other side of each cable 102 is attached to a top part of an anti-twist device 106. A joint tether 103 attaches the bottom part of anti twist device 106 to a ground anchor 107. Ground anchor 107 can take form of a peg or a short tower. In time of normal work, the system of wings 101 rotates under influence of aerodynamic lift, created by the wind, acting on each wing. Direction of rotation is shown by arrows on the dash dot line in FIG. 1. A ground station 109 is provided on the ground. Ground station 109 comprises a pulley 110, rotationally connected to a rotor of an electric generator 111. This connection can be with or without a gearbox. Generator 111 can be installed on top of a yawing platform 112. Cable 114 transmits electrical energy, generated by generator 111, to the consumers or a transformer station. A control system 113 or its ground based part can be installed inside ground station 109 or independent of it. A long belt 108 is spread in the air over some of traction devices 104 and wraps around pulley 110. Traction device 104 ensures traction without slippage between itself and belt 108, when belt 108 touches it. Belt 108 transfers power of motion of wings 101 to pulley 110, which transfers it to the rotor of generator 111, which converts it into electric energy. Direction of motion of belt 108 is shown by arrows near it in FIG. 1.

It should be noted, that tethers 102 and 103 and belt 108 will have drop due to their weight, but are shown as straight line on the figures for simplicity. Imaginary line, connecting ground anchor 107 and anti twist device 106 can be anywhere between 5 and 60 degrees to a horizontal plane in this embodiment, preferably between 15 and 45 degrees. Plane P is inclined to vertical between 1 and 45 degrees, preferably between 5 and 30 degrees, in the direction, opposite to the direction the wind. Aerodynamic forces, acting on moving wings 101, maintain the construction in the air. Wings 101 maintain their desirable trajectory because of inputs from control system 113.

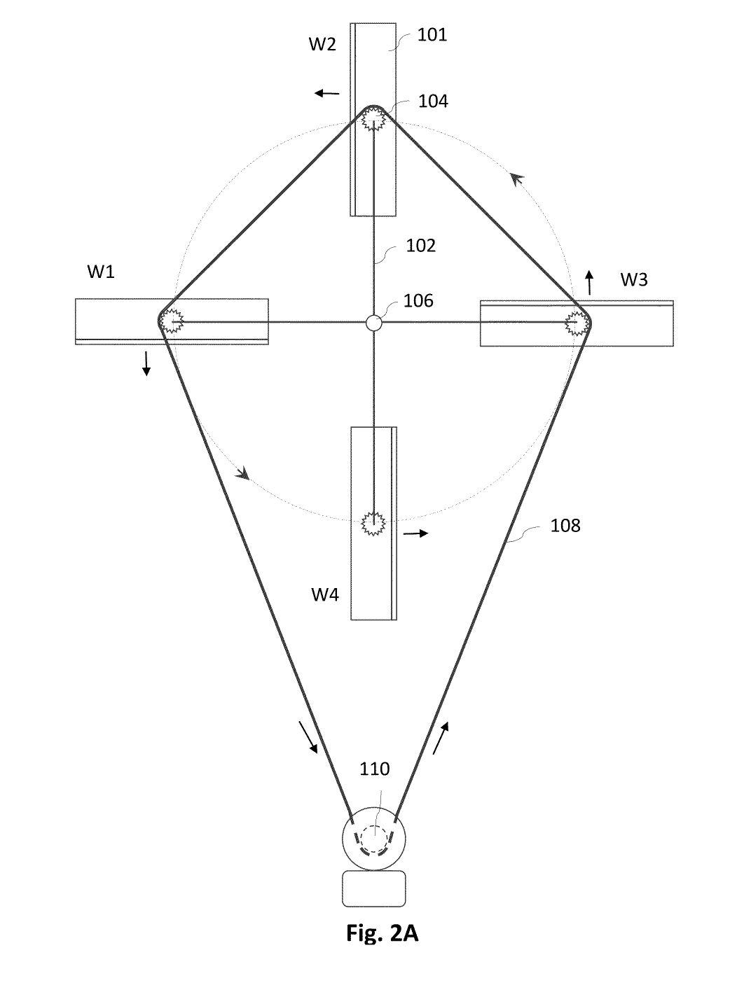

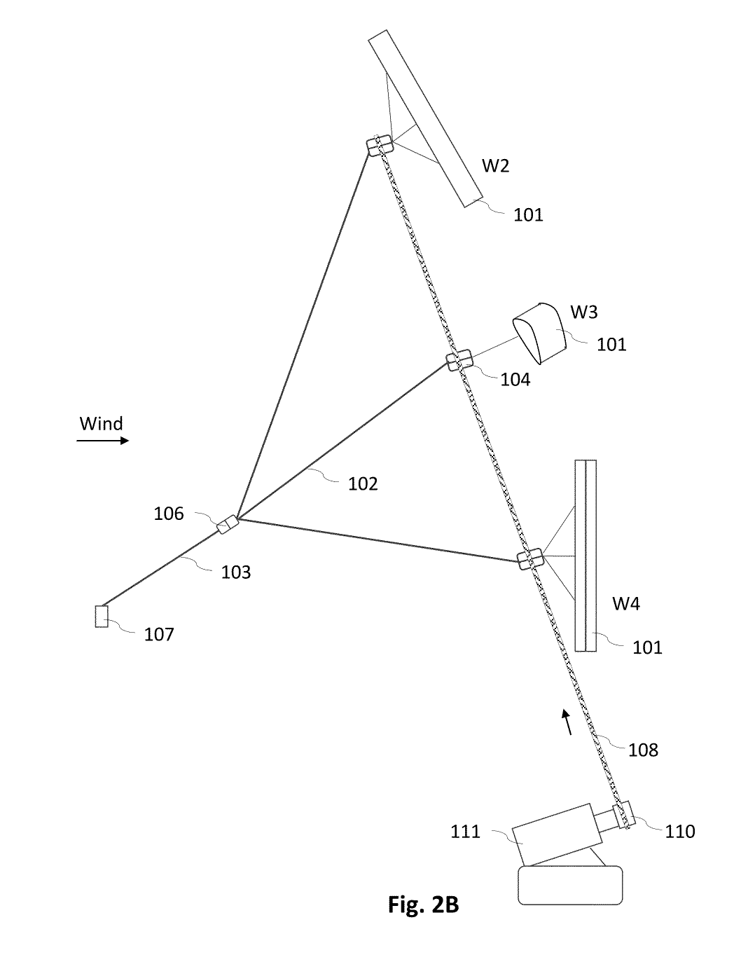

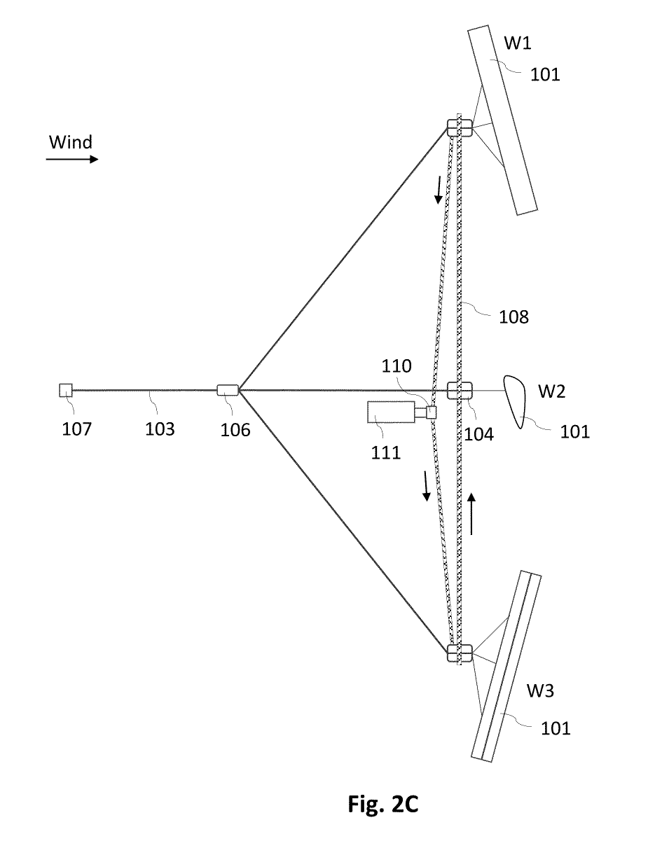

FIG. 2A shows schematic view of details of the same embodiment from the point of view of the ground attachment point at ground anchor 107. Wings 101 are shown in planform, with their leading edge marked by a double line. Dash dot line shows rounded (but not necessarily circular) trajectory of traction devices 104. Arrows near wings 101 show direction of wing's motion. Arrows near belt 108 show direction of the belt's motion. Wings 101 are named W1, W2, W3 and W4.

In FIG. 2A, wings W1, W2 and W3 are in the traction phase. A wing is in the traction phase, when its traction device engages belt 108 and pulls it. Each wing 101 is in traction phase when it is in the upper 180 degrees of its trajectory. A traction sector corresponds to a traction phase. The traction sector is close to 360 degrees, if there are two wings 101 in the system, and decreases as the number of wings in the system increases. In FIG. 2, wing W4 is in non traction phase. When wing 101 crosses from the traction sector into non traction sector, its traction device 104 disengages. When wing 101 is in its non traction phase, the control system prevents excessive acceleration of the wing. This can be done by changing angle of attack to decrease lift or using aerodynamic brakes. Also, the control system ensures that wing's traction device 104 meets belt 108 and engages it correctly, when wing 101 crosses from the non-traction sector to the traction sector.

FIG. 2B shows view of some details of the same embodiment from a side. The view direction is horizontal and perpendicular to the direction of the wind. Remote wing W1 is not shown and another side of belt 108 is invisible. Leading edge of wing W4 and rear edge of wing W2 face the viewer. Wing W2 creates significant force, resisting pull of belt 108 toward ground station 109, because of its angle to plane P. In the same time, wing W2 also pulls belt 108.

FIG. 2C shows schematic top angled view of some details of the same embodiment. Bottom wing W4 is not shown. Leading edge of wing W3 and rear edge of wing W1 face the viewer. Wings W3 and W1 create significant forces, spreading belt 108 horizontally to the sides, while pulling belt 108 in the same time. Generally, when a wing is in a traction phase, it is inclined to plane P so that some of the lift is directed outwards, to resist compression action of belt 108 and “spread” it.

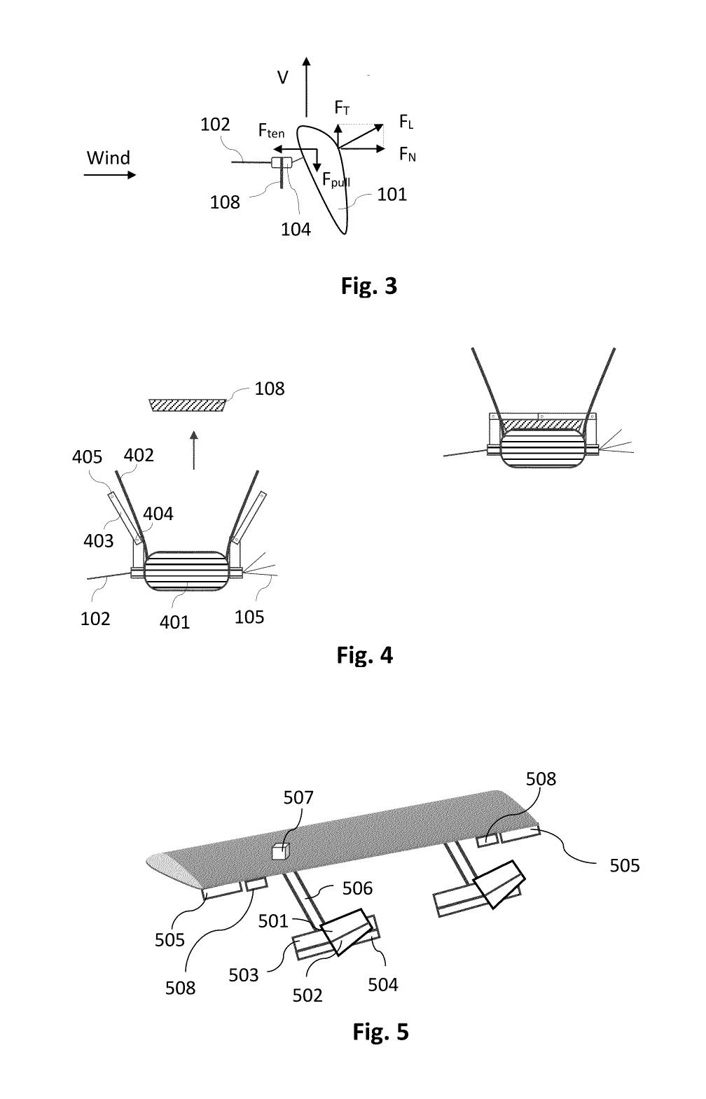

FIG. 3 shows some forces, acting on the wing in the plane of its profile. Vector V shows velocity of the wing.

F_{L}—aerodynamic lift
F_{T}—thrust component of lift, generating the power
F_{N}—normal component of lift, compensated by tension of cable 102
Fₜₑₙ—tension by cable 102
Fₚᵤₗₗ—pull by belt 108

These forces balance add up to a relatively small force, causing radial acceleration of the wing.

In one variant of this embodiment, the lateral axis of the wing is inclined 15° to plane P. The angle of attack of wing 101 is 3°. The wing is cambered; the angles may vary, depending on strength of wind.

FIG. 4 shows traction device 104 in the process of engaging belt 108 by traction device 104. On the left side of FIG. 4 traction device 104 moves in direction of belt 108 (shown in section). Traction device 104 comprises a body 401, having rounded or flat face, two or four guiding rails 402 and a clamp, comprising a pair of braces 403 on hinges 404 with locks 405 on their free ends. The right part of FIG. 4 shows traction device 108 with trapped and engaged cable 108. Braces 403 are closed and locked.

Traction device 104 can also contain sensors, such as a camera, measuring relative positions and velocities of the device and belt 108. The clamp can be magnetic, rather than mechanical.

### Operation of Embodiments AA

Flying cross wind, wing 101 with sufficient L/D ratio can achieve speed of 40-200 m/s in wind speeds of 10-20 m/s. Belt 108 moves with the speed of wing 108. The high speed of belt 108 allows to transmit high power with relatively low tension and relatively thin belt.

While flying along its trajectory, wing 101 continuously changes angles of its three axes in the space to provide forces, necessary to counteract the weight of the system, spread belt 108 sideways and up and pull belt 108 along. Wing 101 can also change angle of attack within limits (avoiding stall).

Control system 113 ensures dynamic stability of the system, modifies trajectory of wings, changes angles of wings depending on their position on trajectory etc.

While not exactly correct, this embodiment can be conveniently visualized as a belt and pulleys system, in which a huge pulley with a circumference containing the centers of wings 101, is hanging in the air at an altitude and is being rotated by wind. The wind direction matches the imaginary axis of this imaginary pulley. Belt 108 transmits rotation from this huge pulley to a little pulley 110 on the ground, causing pulley 110 to achieve high RPM. Diameter of the imaginary pulley can be anywhere between 50 meters and 5 kilometers, wing spans are 2-20 times shorter than this imaginary pulley diameter.

### More Enabling Details and Variations for Embodiments AA

Preferably, wing 101 has a high L/D ratio, and its speed is 4-20 times higher, than the speed of the wind. Pulley 110 can have guards, preventing belt 108 from falling off it. Rollers can be used to push belt 108 and pulley 110 toward each other to increase friction. Yawing mechanism 112 can be omitted in certain embodiments. Cables 102 and/or suspension cables 105 can be made from an aerodynamically streamlined cable, decreasing energy losses for air drag.

Belt 108 can be flat, round, toothed, ribbed, grooved, perforated or V-belt. Other belt types can be used, too. A rope or a cable with round cross section can be used as a belt 108. Material of surface of belt 108 can have high friction with material of surface of pulley 110 and pulley 106. Wing 101 can be any of the following: a rigid airfoil; a flexible airfoil; a soft airfoil; an inflatable airfoil; an inflatable airfoil, inflated by the ram air, entering it through holes; an inflatable airfoil, inflated with lighter than air gas; an airplane airfoil; a kite airfoil; a parafoil; an airfoil, using soft materials, spread over a rigid frame or cables; an airfoil made of elastic fabric, receiving airfoil form from relative air flow; a mixed airfoil, using different construction techniques in its different parts; other types of airfoil.

Wing 101 can be made of various materials, including carbon fiber, fiberglass, aluminum, aramids, para-aramids, polyester, high or ultra high molecular weight polyethylene and other. Wing 101 can have various planforms; it can be tapering to the ends in chord or thickness or both (rectangular planform is shown on the drawings for clarity purposes only). Wing 101 may have wingtips to decrease turbulence and noise. FIG. 5 shows the control system and control surfaces of wing 101. The control surfaces comprise vertical stabilizers 501, rudders 502, horizontal stabilizers 503, elevators 504, ailerons 505 and air brakes 508. The control surfaces 501-504 are installed on the end of a boom 506 and can be combined between them in various combinations (like in stabilators, V-tails etc.). Attached to wing 101 is also a wing control system 507. Wing control system 507 comprises a central processor or a microcontroller, sensors and actuators for the rudders, the elevator and the ailerons, communication means for communication with the ground, and an energy source. The wing sensors may include speed meter, altimeter, accelerometer, gyroscopic sensor, GPS, stall warning device, compass, cameras and other. The energy source can be a battery or a small turbine, working from the air flow. Other types of wings and control elements are possible. Wing control system can serve as a part of total control system 113.

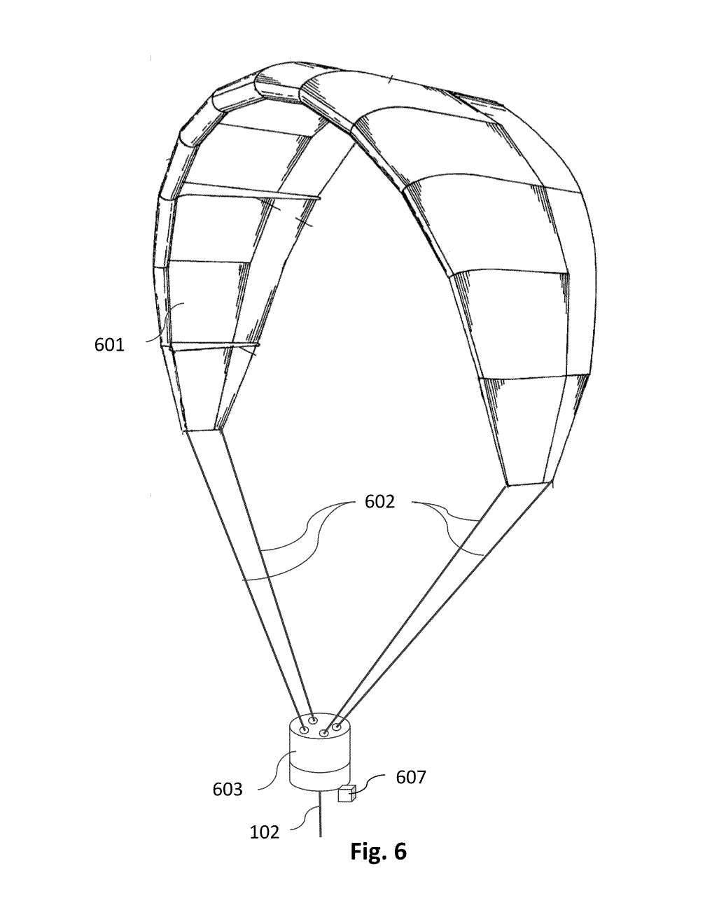

FIG. 6 shows a variation, in which wing 101 is a parafoil. It comprises four combined control and suspension cables 602 and a control mechanism 601, controlled by a wing control system 607. In this form, position of the wing relative to the wind and to the horizon is controlled by control mechanism 601, dynamically changing the lengths of cables 602.

Control system 113, shown on FIG. 1, comprises a ground and airborne components. Airborne components include wing control systems 507 or 607. The ground component of control system 113 comprises a central processor or a microcontroller, optional sensors and communication means for communication with wing control system 507 or 607. One option for communication means is a wireless network, but copper or optical cables, running through tether 103 can be used as well. The ground sensors may include anemometer, barometer, radar, hygrometer, thermometer, GPS, belt tension meter, RPM meter, cameras for observing the wings and other. One control system 113 can serve multiple ground stations. Control system 113 can be connected to the Internet to receive general weather information, especially warnings of extreme weather events. The workload can be divided between the ground and airborne parts of control system 113 as follows: the ground part computes desired changes in the wing course, while control system 507 or 607 of the wing computes and issues precise inputs for the control surfaces, necessary to execute those changes or to keep the direction and the speed unchanged.

Anti-twist device 106 is provided in order to prevent rotation of tether 103. Anti-twist device 106 comprises a top part and a bottom part, capable of rotating one relative to another on ball bearings. In a more complex embodiments, it can be provided with its own direction sensor (gyroscopic, magnetic or GPS) and a servomotor, compensating remaining twisting moment and keeping turn angle within plus minus 60 degrees. Additional tightening pulleys can be placed next to pulley 110 in order to increase engagement between it and belt 108. Additional guide pulleys can be placed next to pulley 110 in order to ensure right angle between it and belt 108.

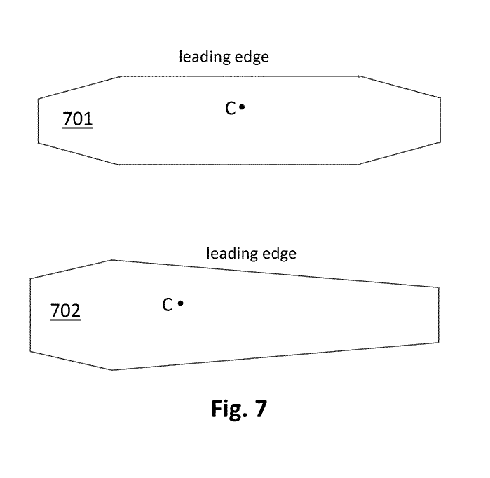

FIG. 7 shows some planforms of wing 101, that can be used in various embodiments of the invention. Planform 701 is symmetrical. It is suitable for embodiments, in which diameter of the imaginary pulley is much larger than wing span (for example, 10 times larger). Planform 702 is asymmetrical, with wider end toward the center of the imaginary pulley. It is suitable for embodiments, in which diameter of the imaginary pulley is not much larger than wing span (for example, only 2 times larger). Thick dot with a letter C next to it denotes center of the wing.

The systems, described above, work efficiently only if wind's direction is close to the vector ground anchor 107—ground station 109. There is a large number of locations where a wind blows within a small sector most of the time, and where these systems can be efficiently utilized as described above. Also, these systems can be utilized in offshore locations by placing ground station 109 on a buoy, co-anchored with offshore equivalent of ground anchor 107, as described in PCT/US12/66331. In it, the ground station slowly moves, so that the vector anchor—station gets aligned with the wind direction.

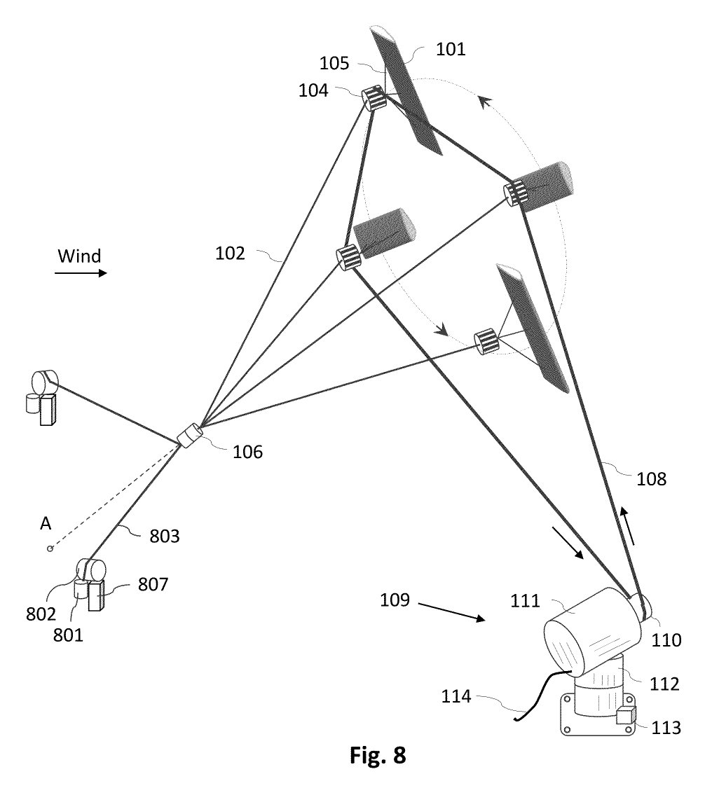

FIG. 8 shows a solution for other cases, when wind can blow from any direction. In this solution, at least one motorized anchor 807 is equipped with a small engine 801 and a pulley 802. Combined, they constitute a motorized pulley. This motorized pulley, automatically operated by control system 113, can slowly (compared with the speed of the wings) change length (by pulling in or releasing) of cable 803, connected to anti-twist device 106, thus changing its horizontal position and “effective anchor point”. FIG. 8 shows two such motorized ground attachments with motorized pulleys. Dashed line shows position of the equivalent effective anchor point A. Three motorized anchors 807, installed in vertices of equilateral with center in ground station 109 allow to move effective anchor point full circle, and also to change its distance to ground station 109. Thus, it is possible to align the vector anchor-station with any direction of the wind. This solution can be used with other airborne wind energy systems, including but not limited to the embodiments of this invention.

### Advantages of Embodiments AA

This embodiment should be compared to two the airborne wind energy conversion system, that resembles it most—the original Laddermill and Kitegen Stem, or a pumping mill.

The advantage of this embodiment of the invention over Laddermill:
cross wind motion of the wings allows to produce more energy for the same wing size; the improvement can be by an order of magnitude
higher speed of the belt allows to transmit more mechanical power to the ground generator with the same or smaller belt cross section; the improvement can be by an order of magnitude
higher RPM can be achieved on the ground pulley, allowing not to use a gearbox, or use a small gearbox

The advantage of this embodiment of the invention over pumping action systems, such as KiteGen Stem:
higher speed of the belt allows to transmit more mechanical power to the ground generator for the same belt cross section; the improvement can be by an order of magnitude
higher RPM can be achieved on the ground pulley, allowing not to use a gearbox or use a small one
a drum with a cable is not required
switching of electric generator between generator and motor modes is not required
continuous production of electrical energy

### More Embodiments

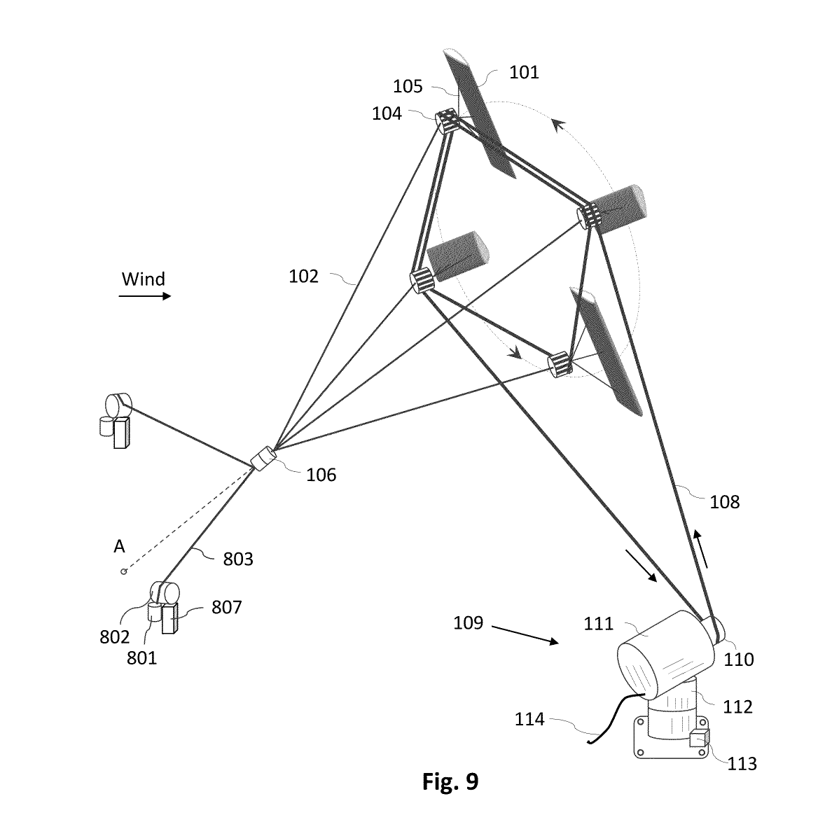

FIG. 9 shows another embodiment. It is similar to the system in FIG. 8, but belt 108 makes another wrap around imaginary huge pulley. Thus, every traction device engages belt 108 in at least one place at any time, and every wing is in traction phase all the time. This requires obvious modification to traction device 104, allowing it to hold simultaneously two belt pieces, and release one of them, acquired earlier, in the pre-determined point. The advantage of this embodiment is that each wing converts wind energy all the time.

FIG. 10 shows another variation of the system. The direction of the view is at angle 30 degrees to horizon, with the wind from the back of the viewer. This system is similar to the system from FIG. 1, with the main difference that the wings are attached to a flexible ribbon, which transfers motion to belt 108. A large (having diameter of 20-5,000 meters) ribbon loop 1001 is placed in the air. Two or more wings 101 are attached to ribbon 1001 and are moving cross wind with a speed, exceeding speed of the wind. FIG. 10 shows a variant of the system with five wings. Wings 101 are attached to ribbon 1001 near wing's centers and at equal distances one from another. Wing's attachment allows significant freedom of rotation of wing 101 in all three planes. The trajectory of the centers of all wings 101 is the same and it is a closed curve, possibly a deformed circle in a plane, which we will call plane P. Each wing is held by a wing cable 102, which can be attached to the wing's center or to suspension cables (not shown), distributing load over the surface of the wing. Other side of each cable 102 is attached to a top part of an anti-twist device 106. A joint tether 103 attaches the bottom part of anti-twist device 106 to a ground anchor 107. Ground anchor 107 can take form of a peg or a short tower. In time of normal work, ribbon 1001 with wings 101 rotates under influence of aerodynamic lift, created by the wind, acting on each wing. Direction of rotation is shown by a curved arrow near ribbon 1001. Ground station 109 is provided on a ground. Ground station 109 comprises pulley 110, rotationally connected to the rotor of electric generator 111. This connection can be with or without a gearbox. Generator 111 can be installed on top of a yawing platform (not shown). Control system 113 or its ground based part can be installed inside ground station 109 or independent of it. Long belt 108 connects ribbon 1001 and pulley 110 without slippage on either ribbon 1001 or pulley 110. Thus, belt 108 transfers power of motion of wings 101 to pulley 110, which transfers it to rotor of generator 111, which converts it into electric energy. Direction of motion of belt 108 is shown by arrows near it in FIG. 10.

FIG. 11 shows view of some details of this system from a side. The view direction is horizontal and perpendicular to the direction of the wind. Remote wings are not shown. FIG. 11 shows that wings 101 are inclined to plane P so that some of the aerodynamic lift is directed outwards, to maintain rounded form of ribbon 1001.

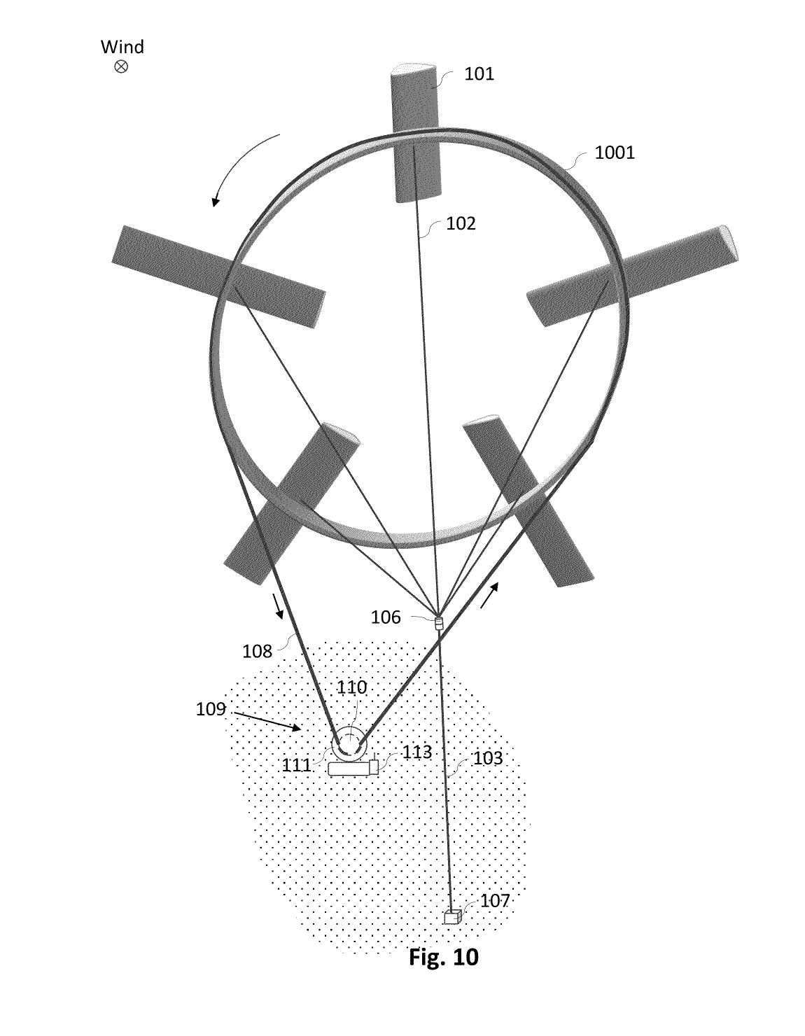

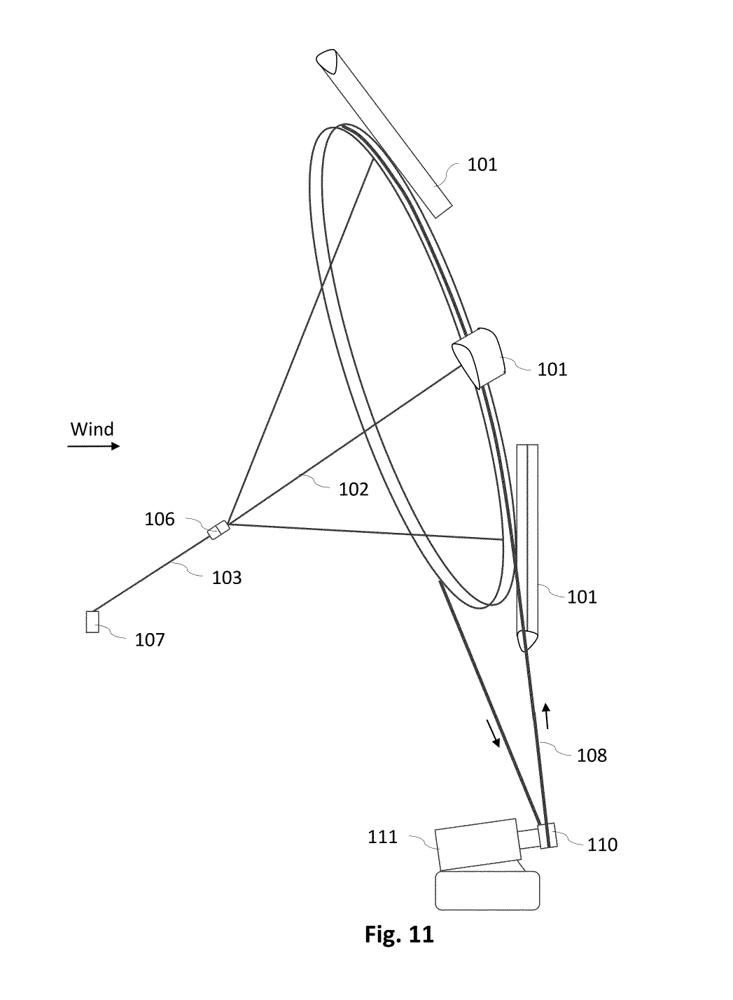

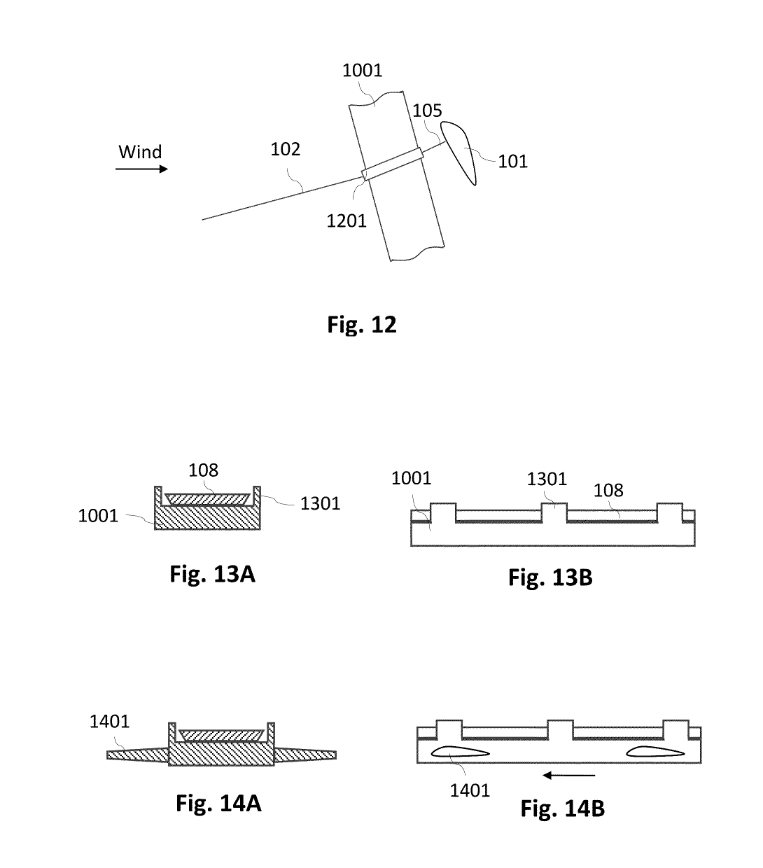

FIG. 12 shows view of attachment of wing 101 to ribbon 1001, as viewed from the center of ribbon 1001. A rigid rib 1201 is attached to a ribbon, along its internal surface and close to 90 degrees to its long side. Cable 102 is attached to rib 1201 on one end. Wing 101 is attached by suspension cable 105 to rib 1201 on another end. Thus, the normal component of the aerodynamic lift on wing 101 in the visible plane is balanced by pull of tether 102, and remaining thrust component acts on rib 1201 and, through it, on ribbon 1001, accelerating it at start and maintaining its motion.

FIG. 13A is a sectional view of belt 108 and ribbon 1001 in contact. FIG. 13B is a side view of belt 108 and ribbon 1001 in contact. They show a raised edge 1301 in ribbon 1001, preventing belt 108 from slipping off the sides of ribbon. Further, outward surface of ribbon 1001 can be ribbed, toothed or covered with high friction material to prevent slippage against the direction of ribbon motion.

Ribbon 1001 can be made of various strong and flexible materials, including synthetic fibers, thin steel, aramids, para-aramids, polyester, high or ultra high molecular weight polyethylene. Ribbon 1001 maintains its rounded form in plane P, first of all, because of centrifugal forces, acting on it when it rotates at high velocity. It may be desirable to increase outward forces, acting on it between the points of wing attachment. One way to achieve it is to use spring force by making ribbon 1001 of steel band, pre-stressed in the opposite direction.

FIG. 14A (sectional view) and FIG. 14B (side view) show another solution. Small winglets 1401 are attached to (or formed on) sides of ribbon 1001. When ribbon 1001 rotates, these wings create aerodynamic lift, directed outwards. This solution is especially effective at larger diameters (i.e., >200 meters), at which centrifugal forces are weak.

Ribbon 1001 can rotate with speed 40-200 m/s. The system can be further modified by using multiple motorized ground anchors or offshore deployment and/or other modifications described above. In addition to the advantages described above, each wing 101 captures and converts wind energy all the time, including when it is in the bottom sector and its ribbon attachment point is not in contact with belt 108. Also, continuous ribbon loop 1001 eliminates traction devices 104.

A rigid circular wheel or a wheel with spokes can be used instead of ribbon 1001, although flexible ribbon loop is lighter and provides more options for movement of wings 101.

Under proper automatic control, this system can stay in the air and operate for months. Nevertheless, it needs to be raised and brought down periodically. Some methods of raising this system:

### I) External Lift.

Disengage electric generator 111. Temporary attach some of belt 108 to ribbon 1001. Hook up ribbon 1001 from a helicopter or a blimp and raise it in the air. Wings should be kept stalled or at neutral angle to the wind, if the wings are rigid; wings should be partially folded, if the wings are soft. When ribbon 1001 is in the desired place in the air, simultaneously move wings to a position with effective angle of attack (typically under 15 degrees). Ribbon starts rotating. Disengage the hook, allow belt 108 freely move. In the absence of mechanical resistance from generator 111, ribbon will accelerate and will move away from anchor 107 as far as tether allows. When the ribbon has accelerated to working velocity, smoothly engage electric generator. This should be performed as a separate use case in the control system program.

A variation of this idea is to use multiple balloons or a big enough balloon to grab ribbon 1001 in many places, preferably at the wings. Another variation of this method is to fold the ribbon (if it is foldable) and install wings one on top another, like in bookshelves, then raise this packet into the air and drop. After starting falling, the wings will obtain velocity and become controllable. Use control to give the ribbon circular form and start the rotation.

### II) Self Start.

Disengage electric generator 111. Temporary attach some of belt 108 to ribbon 1001. On the ground, turn all wings in parallel at the same angle to the wind. The wings should be facing wind with their leading edge, having effective angle of attack. Ribbon 1001 with wings 101 and belt 108 will raise in the air horizontally. Decrease angle of attack of the wings on the windward side for ribbon 1001 to achieve its inclined attitude. When ribbon 1001 arrives to its desired position in the air, smoothly turn some of the wings in the opposite direction into a position with effective angle of attack. Ribbon starts rotating. Allow belt 108 freely move. In the absence of mechanical resistance from generator 111, ribbon will accelerate and will move away from anchor 107 as far as tether allows. When the ribbon has accelerated to working velocity, smoothly engage electric generator. This should be performed as a separate use case in the control system program.

Descent and landing can be performed by reversing these steps.

### III) Expendable Lift and Descent.

Use multiple expendable balloons, attached to wings 101, ribbon 1001 and, possibly, belt 108. Start as in external lift case. As ribbon 1001 starts rotating, let the balloons go. For landing, the system should have a landing kit, consisting of a folded balloon, a container with compressed gas lighter than air, such as hydrogen, methane or helium and a gas release device, attached to each wing 101 and some places on ribbon 1001. The kit should be inside of the wing or in a streamlined and properly oriented container, of course. To land, decelerate rotation of ribbon 1001, disengage generator 111 and release compressed gas into the balloons. Balloons will inflate. Lifting power of the balloons should be computed to almost compensate for weight of ribbon 1001 and wings 101. Ribbon 1001 and wings 101 will slowly descend to the ground. Parachutes can be used instead of landing kits.

This is a universal method for raising and landing AWECS. It can be used with other airborne wind energy conversion systems. Other methods of raising and landing wings can be used with certain modifications in suitable embodiments of this inventions and other AWECS.

### IV) Smaller Wing.

A larger wing can be launched using a smaller wing. A ribbon with multiple wings can be launched using small rotary dynamic sail.

V) External Lift Allowing Natural Motion.

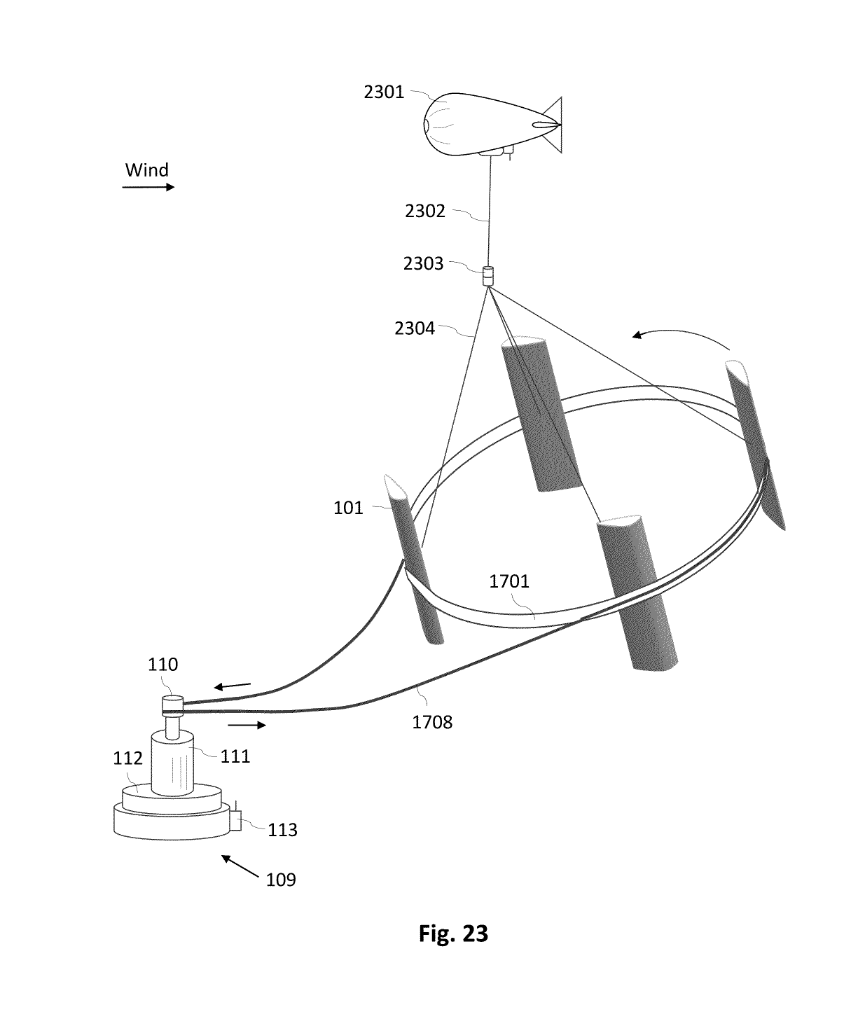

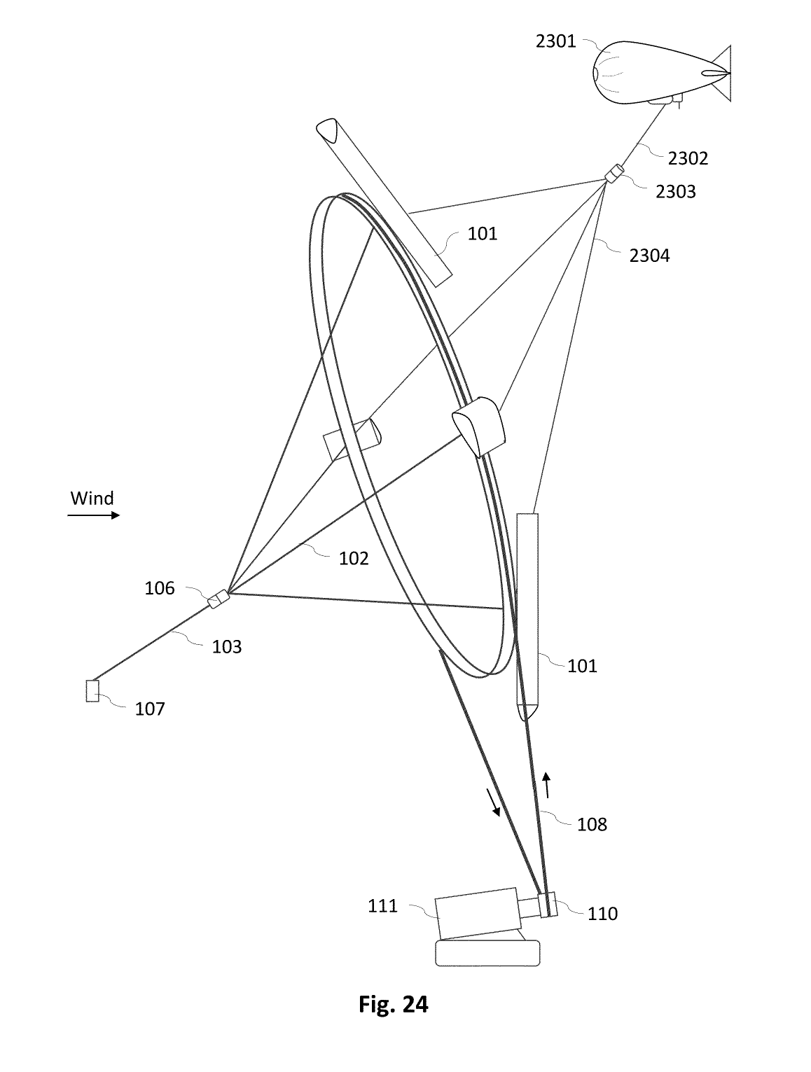

See FIGS. 23 and 24 and descriptions to them.

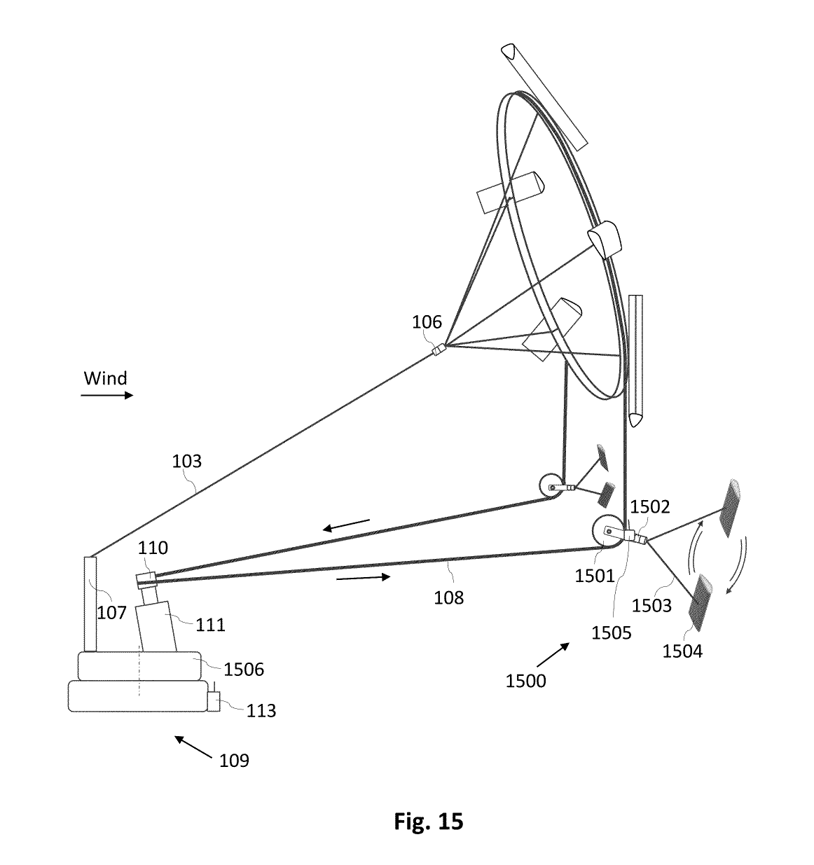

FIG. 15 shows a side view of another embodiment. It comprises familiar parts from embodiments, described above. One difference is that it has anchor 107 and generator 111 installed on horizontally rotating (yawing) platform 1506. Platform is rotated by an electrical motor in such direction as to put anchor 107 upwind, and pulley 110 downwind. Additionally, there is a pair of pulleys 1501, attached to rotary dynamic sails (RDS) 1500. Each pulley 1500 freely rotates around its axle. RDS 1501 comprises an anti-twist device 1502, a pair of cables 1503, a pair of wings 1504, each connected to its cable 1503 and an RDS control system 1505. Belt 108 is wrapped around pulleys 1501. Wings 1504 move cross wind in a circle under power of wind. The plane of rotation is inclined about 45 degrees to the horizon and perpendicular to the viewed plane. The force of wind, acting on pair wings 1504, is directed perpendicular to this plane. This force compensates pressure of belt 108. Thus, belt 108 is brought to pulley 110. Wings 1504 are similar, in principle (but not necessarily in size) to wings 101. Anti-twist device 1502 is similar to anti twist device 106. Sum of forces from wings 1504, acting on anti-twist device 1502 is a force, directed perpendicular to the plane of rotation of wings 1504. Components of forces in the plane of rotation of wings 1504 compensate one another and sum up to zero. This embodiment requires frequent (up to 100 times per seconds) inputs from the control system to balance flying pulleys 1501, but decreases land footprint of the system to the size of the fundament or tower, on which platform 1506 is installed.

RDS control system 1505 maintains balance of the mechanical parts in motion. Such RDS can be used to create force of any specified value (up to a limit, determined by size and strength of the mechanical components) in any specified direction from 0 degrees to 70-85 degrees from the direction of wind (efficiency is the highest at 0-30 degrees and drops sharply as the angle approaches 90 degrees). This is accomplished by changing angle of plane of rotation of wings 1504. Direction of the force is always perpendicular to this plane. By changing angle of attack of wings 1504, the control subsystem can provide required value of force in wide range of wind strengths. Of course, some wind is always required. Thus, RDS can be used in wind energy conversion systems instead of static strength elements, creating bending moment or compression. It should be noted, that relatively little control inputs are required to use RDS in wind energy devices, because its direction should remain constant relative to wind, and force, created by it should be proportional to the force, created by wind on other moving airfoils of the system, and both proportional to wind velocity in square. RDS can be used in any wind based devices, where single or double “figure eight” wing motion has been suggested before. Circular motion of the wings in RDS have advantage over “figure eight” of the same size, because it can be performed with at least two times lower maximum acceleration. In one particular embodiment of RDS, the lateral axis of the wing 1504 are inclined 10° to the plane of their rotation, and the angle of attack is 3°. Wing 1504 is cambered; the angles vary, depending on strength of the wind and the required force. In another embodiment of RDS, longitudinal axis of wing 1504 has constant angle 5° to the plane of rotation, and angle of attack changes with the position of the wing in the circle. Multiple sets of wings, rotating in parallel planes around the same axis can be attached to a single anti-twist device by using an additional cable and connecting each set of wings to this cable in different places. Other variations of RDS can be found in PPA-03, referenced above.

Referring again to FIG. 15, it is possible to change altitude at which ribbon 1001 with wings 101 operate by changing force, with which RDS acts on belt 108.

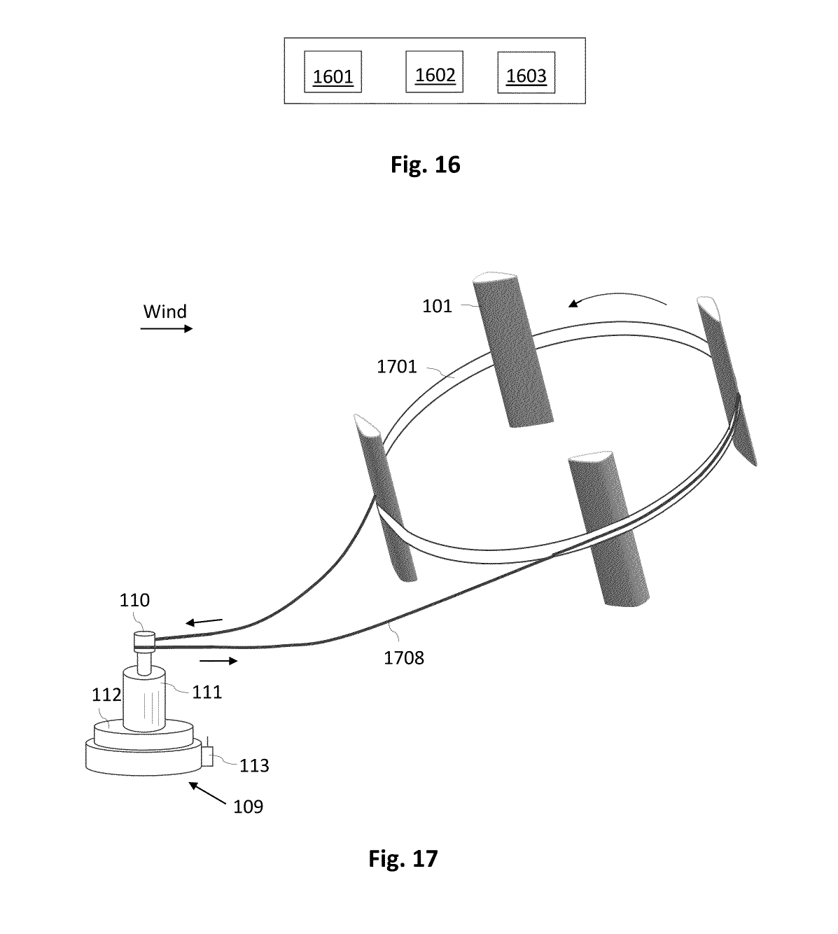

FIG. 16 describes the control system, comprising a CPU 1601, a sensor 1602 and an actuator 1603.

FIG. 17 shows another embodiment of the invention. The direction of the view is from a side and slightly above, with the wind from the left. A large (having diameter of 20-10,000 meters) ribbon loop 1701 with attached two or more wings 101 is placed in the air. FIG. 17 shows four wings 101. Ribbon 1701 rotates in its own plane under the power of the wind, acting on wings 101, as explained below. The plane of ribbon 1701 is slightly inclined to horizon in the direction of the wind (with angle 5-45 degrees). Preferably, wings 101 are attached to ribbon 1701 near wing's centers and at equal distances one from another. The wing's attachment allows wing 101 to change at least angle between its longitudinal axis and the ribbon and angle between its lateral axis and the plane of motion. The trajectory of the centers of all wings 101 is the same and it is a closed curve, possibly a circle or a deformed circle in the plane of motion. The speed of wings 101 exceeds speed of wind more than two times. Direction of rotation of ribbon 1701 is shown by a curved arrow near it. Ground station 109 is provided on the ground. Ground station 109 comprises pulley 110, rotationally connected to the rotor of electric generator 111. This connection can be with or without a gearbox. Generator 111 is installed on top of platform 112. Control system 113 or its ground based part can be installed inside ground station 109 or independent of it. A long belt 1708 connects ribbon 1701 and pulley 110 without slippage on either ribbon 1701 or pulley 110. Thus, belt 108 transfers power of motion of wings 101 to pulley 110, which transfers it to the rotor of generator 111, which converts it into electric energy, which is then delivered to customers. Direction of the motion of belt 108 is shown by arrows near it in FIG. 17. FIG. 17 shows an embodiment in which pulley 110 is in vertical position and belt 1708 arrives to it in horizontal position because it drops under its own weight. When direction of the wind changes, ribbon 1701 with wings 101 and belt 1708 will shift naturally to be downwind. Position of pulley 110 does not change. In another embodiment, additional pulleys can be provided to guide belt 1708 to pulley 110, or pulley 110 can be at an angle to the vertical and platform 112 can be made yawing to follow ribbon 1701. Centers of neighboring wings 101 can be connected by mechanical cables (not shown) in order to relieve pressure, with which wings push ribbon 1701 outwards.

Ribbon 1701 is held in the air by aerodynamic lift forces, acting on moving wings 101.

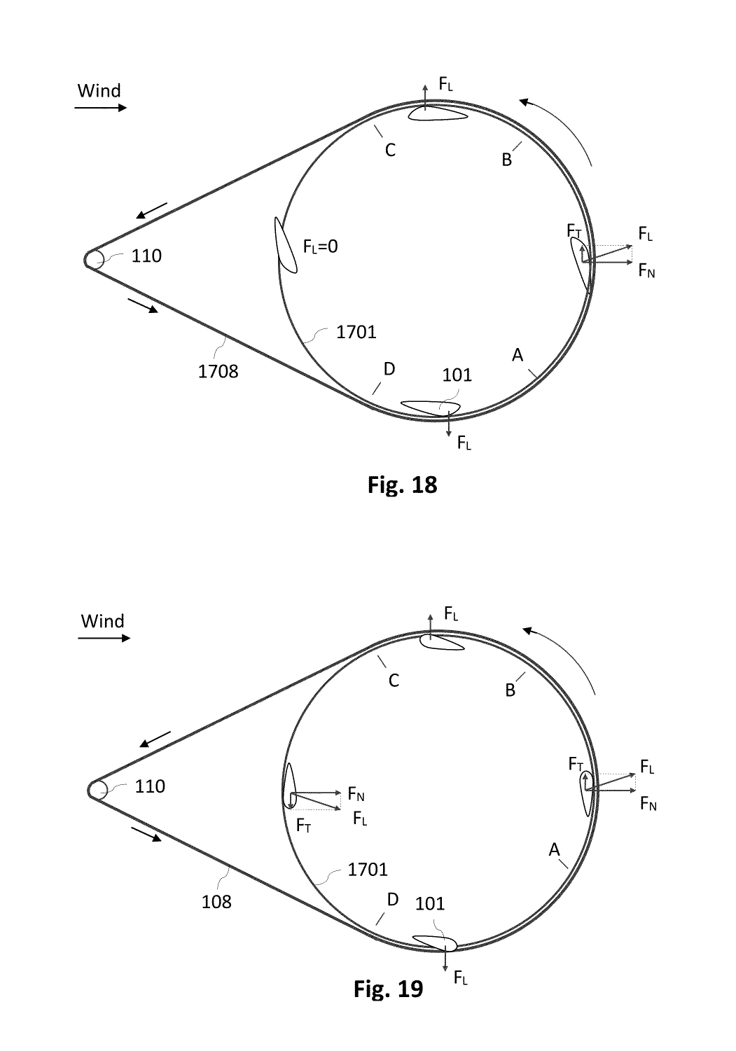

FIG. 18 is a schematic view of some details of embodiments AE, from above and perpendicular to the plane of motion. Points A, B, C and D delimit the closed trajectory of wings 101 into four section. It should be noted, that control system 113 actively and continuously changes the angle of the lateral axis wing 101 to the plane of the ribbon and the angle of attack of the wing to achieve the result, shown in FIG. 18 and the description. Most energy is produced by wing 101 when it is in the section AB, as can be seen from the forces diagram. The trajectory is not necessarily circular. Some kinetic energy is consumed in section BC and DA. In these sectors, aerodynamic lift is present and directed outwards, preventing ribbon 1708 from collapse. Three different possibilities exist in the section CD:

a) wing 101 has angle of attack, creating zero aerodynamic lift; this angle is negative for the cambered wing shown in FIG. 18; section CD of ribbon can be flattened
b) wing 101 has angle of attack, creating small aerodynamic lift and generating little power; still negative angle of attack for asymmetrical wing; section CD of ribbon can be flattened
c) wing 101 has angle of attack, creating significant aerodynamic lift and generating significant power

Option c) produces most energy, but is also the most difficult to attain, since something should compensate wind pressure on the wing, attempting to collapse the ribbon's form. This something can be inertia of the wing, inertia of the segment of ribbon or spring force of ribbon. Option c) is more likely to be implemented when diameter of ribbon 1701 is small. When option c) is implemented, symmetrical wing can be more efficient than asymmetrical, as shown in FIG. 19.

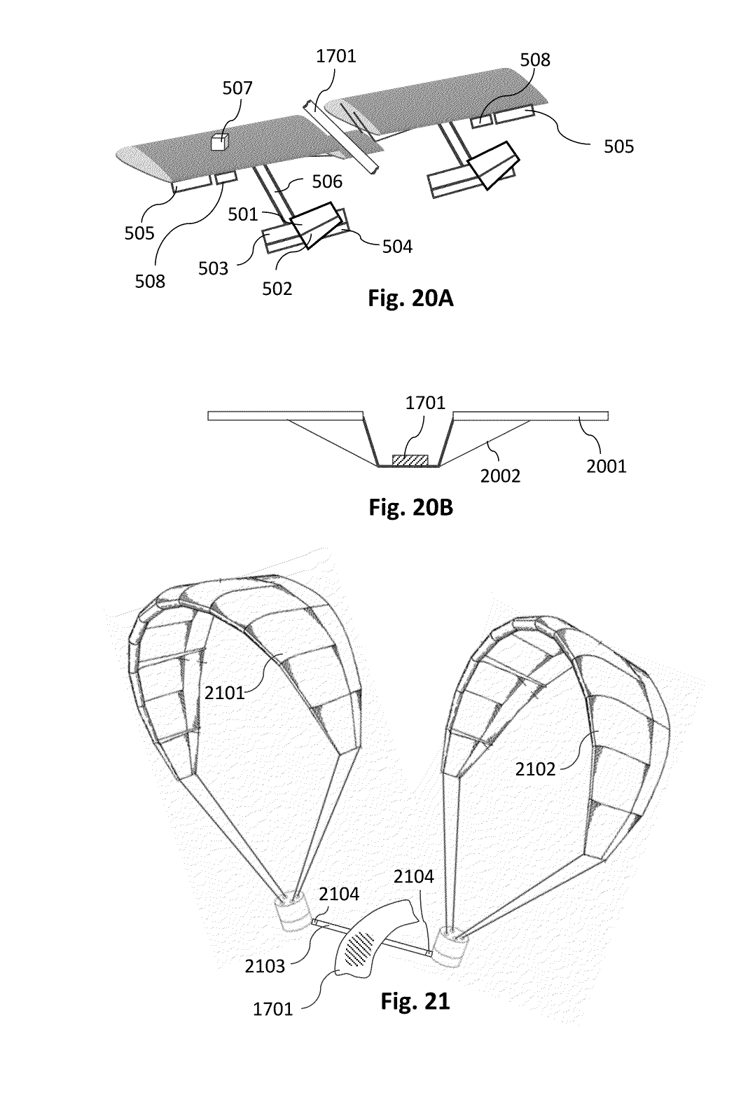

FIG. 20A shows a form of wing 101. It is similar to the wing, described above and shown in FIG. 5, except that there is a lowered section in the middle of it with ribbon 1701, attached to its back. The lowered section allows the wing to rotate in two planes relative to ribbon 1701, as required, without putting excessive stresses on ribbon 1701. Also, it is useful to use suspending struts or cables 2002 between the lowered section and the rest of the wing in order to distribute the ribbon pressure over all the surface of the wing at least in the parts of the trajectory, when aerodynamic forces are at maximum (in the sector AB).

FIG. 20B shows some details of wing 101 for embodiments AE, that are difficult to see on FIG. 20A. It is a view from the front of the wing. Lift creating surfaces 2001 and suspension cables 2002 are seen clearly.

FIG. 21 shows another form of wing 101. It comprises two smaller wings 2101 and 2102, each of them is similar to the wing, shown on FIG. 6. Smaller wings 2101 and 2102 are connected by a cylindrical rod 2103, which is attached to ribbon 1701. Each of the wings 2201 and 2202 can be controlled separately. Wings 2101 and 2102 are attached by rings 2104, that can rotate around rod 2103. With proper control inputs, the combined wing achieves required position downwind from ribbon 1701 through the whole cycle.

It should be noted, that wings 101 are not tethered here, but are being held by ribbon 1701 and belt 1708. Ribbon loop 1701 is similar to ribbon loop 1001, but stronger for the same power. Belt 1708 is similar to belt 108, but stronger for the same power.

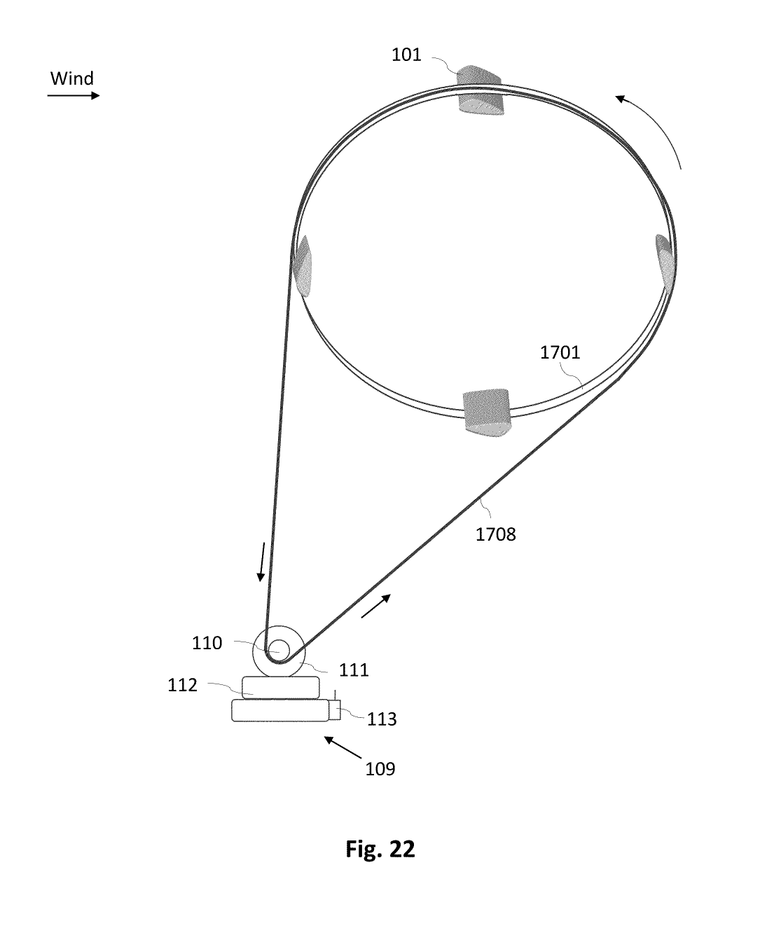

FIG. 22 shows a system, that can be obtained from the system in FIG. 17 by turning ribbon 90 degrees around the axis of the wind direction. Ribbon 1701, belt 1708 and wings 101 remain in the air because of difference in the lift, acting on the upper and the lower parts of the ribbon: positive angle of attack and a significant lift in the upper part of the trajectory, zero or negative angle of attack and small aerodynamic lift in the lower part of the trajectory. Ribbon 1701 can be turned at other angles around axis, created by the wind direction. The form, taken by ribbon 1701, is not necessarily a circle (which is drawn for convenience of visualization). This embodiment takes advantage of the fact that the bottom part of belt 108 is pulling, and experiences larger forces than the top one.

Another system can be obtained by eliminating ribbon 1001 and allowing wings 101 to disengage and fly freely in the non traction phase from one side of belt 108 to another. In this system, wing 101 is not tethered to the ground or to other parts of the construction, so inertia of wing 101 is used to prevent wing from being blown off by the wind. Also, detachment point may be made closer to the ground station, thus decreasing the free flight distance.

In the systems with ribbon 1001 or 1701, described above, an inflatable ring, inflated with lighter than air gas can be attached to the ribbon along its length. This inflated ring will raise and keep the airborne part of the construction in the air in the absence of the wind. Deflating this inflated wing will allow to smoothly bring the construction down. The inflated ring will not interfere with movement of the ribbon or the wings. It can also be integrated with the ribbon and help to keep the convex form of the ribbon.

FIG. 23 shows another variation of the system. It is similar to the system in FIG. 17 (cross flow rotor), but the airborne part of the construction has additional support from a lighter than air balloon 2301. A cable 2302, attached to balloon 2301, holds an anti-twist device 2303, which holds multiple lines 2304. The other end of each line is attached to wing 101 at its center, or to ribbon 1701 at the wing attachment. Balloon 2301 allows to easily raise or lower the airborne structure (wings 101 with ribbon 1701 and belt 1708), keep it in the air in time of slow wind, and eliminate energy loss for keeping it in the air. Optionally, balloon 2301 is used only temporary, to raise to the air or lower to the ground the airborne construction, and then detached. After detaching from one device, balloon 2301 can be used to raise or lower the airborne part of another device. Balloon 2301 has preferably streamlined form to minimize wind drag. A kytoon can be used instead of balloon 2301. Anti-twist device 2304 is similar to anti-twist device 106. This support does not interfere with rotation of ribbon 1701.

FIG. 24 shows a similar system, in which balloon 2301 supports an airborne construction, similar to one depicted in FIG. 10 and FIG. 11 (axial flow rotor).

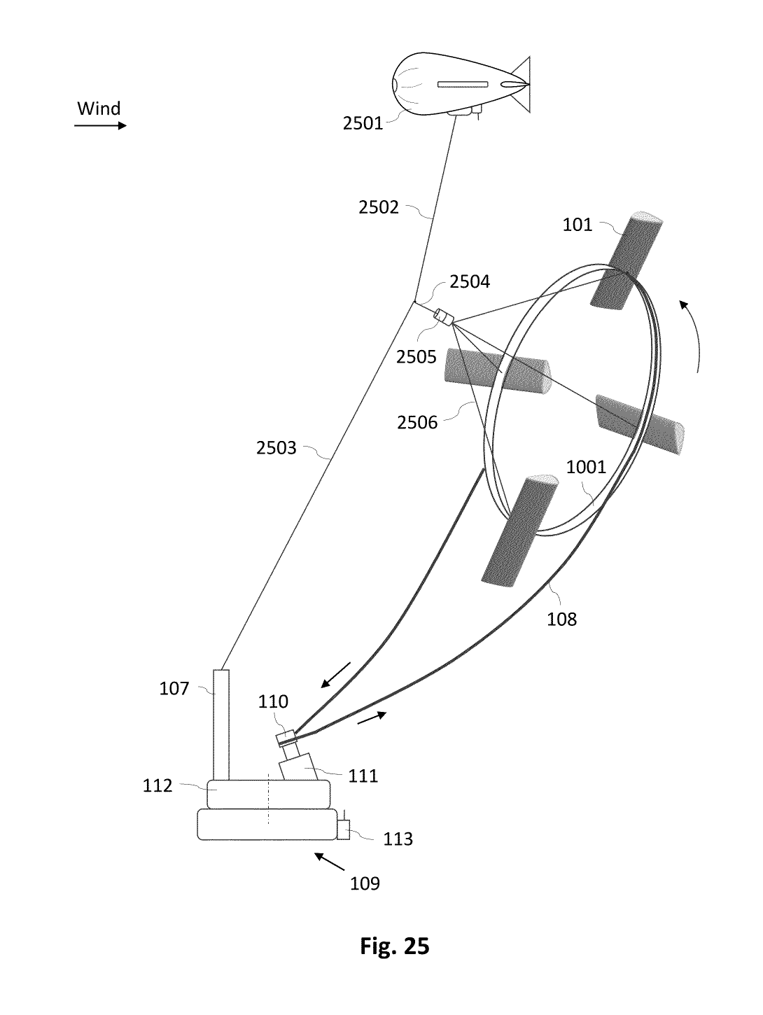

FIG. 25 shows another system, comprising a sky anchor 2501. Sky anchor 2501 can take form of a kytoon, a balloon or a dynamic sail, like rotary dynamic sail 1500, described above, or some combination of them. Kytoon has many advantages, as it allows to raise, lower and keep the airborne construction (wings 101, ribbon 1001 and belt 108) in the air in the absence of the wind, and provides increased tension on a cable 1502 as wind increases and its pressure on the airborne construction increases, too. Cable 2502 is attached to sky anchor 2501 and meets two other cables in one point: ground tether 2503 and another tether 2504. Tether 2504 is attached to the upper part of an anti-twist device 2505. Lines 2506 are attached to the bottom part of anti twist device 2505. The other end of each line 2506 is attached to wing 101 at its center, or to ribbon 1001 at wing attachment. Anti-twist device 2505 is similar to anti-twist device 106. Each wing 101 is supported by one line 2506. Ground station 109 is provided. It has platform 112, rotating in horizontal direction, pulley 110, rotationally connected to generator 111, installed on platform 112 and ground anchor 107, installed on same platform 112. There is control system 113. Tether 2503 is attached to ground anchor 107. Belt 108 wraps around ribbon 1001 and pulley 110, transferring mechanical power, harvested by wings 101 from the wind, to pulley 110, which transfers it to the rotor of generator 111, which transforms it to electrical energy. Details of construction and operation of wings 101, ribbon 1001 and belt 108 are similar to those in embodiments from FIG. 10 and FIG. 11. Details of construction and operation of ground station 109 are similar to those in FIG. 15. Sky anchor 2501 here is different in its function from balloon 2301. In addition to helping to raise and to keep the airborne parts of the construction to the air, pull of sky anchor 2501 allows to change inclination of plane P of ribbon rotation from direction, opposite to the wind, to direction of the wind. Thus, intersection of plane P with the ground in this embodiment lies between vertical projection of the ribbon center to the ground and tether anchor 107. Combined with gravitational drop of belt 108, this allows to bring belt 108 to pulley 110. Sky anchor 2501 resists wind pressure, acting on rotating wings 101, which is many times stronger, than weight of the airborne parts of the construction.

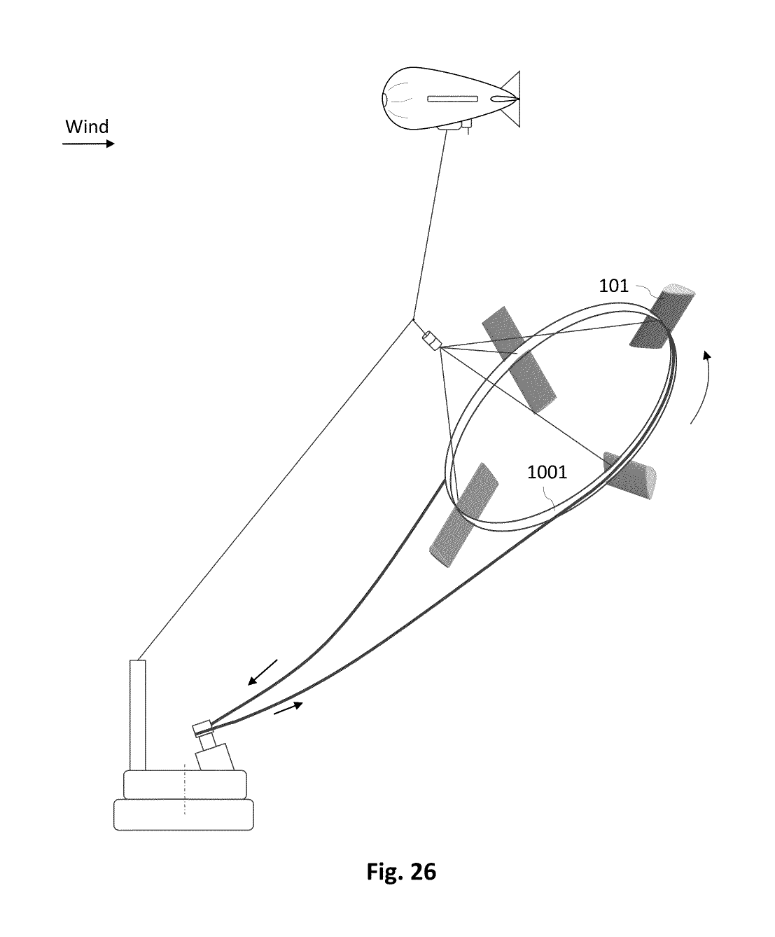

FIG. 26 shows a system that can be called a diagonal flow rotor with a ribbon. It is similar to the previous one, but has larger angle between plan P of ribbon and vertical (30-60 degrees), and more complex behavior of the wings. The wings change their angle of attack and angle between their lateral axis and plane of ribbon in wide range, as the wing passes through its trajectory. This system tries to capture benefits of both axial and cross flow rotors.

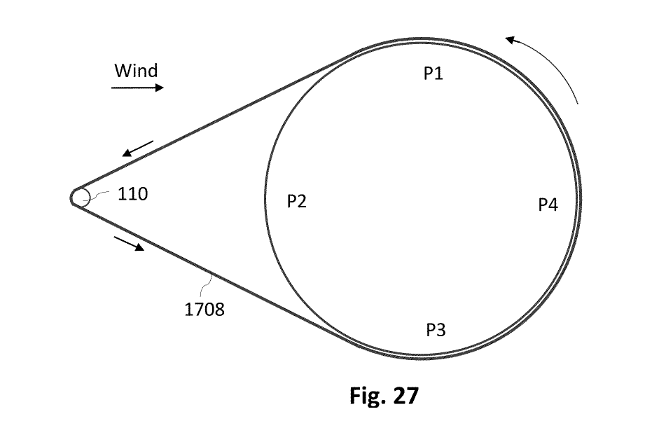

FIG. 27 shows positions P1, P2, P3 and P4 of wing 101 in its trajectory. In reference to FIG. 27, wing 101 is cambered, is angle between plane P and horizon is 45 degrees, altitude of ribbon center is 2,000 m, diameter of the ribbon circle is 500 m, wing span is 50 m, in time when the wind speed at the altitude is 20 m/s. Control system 113 provides input commands, to change angle of lateral axis of wing 101 to the plane of rotation of the wings from 15° in P2 to 75° in P4.

FIG. 28 shows another variation of the system, in which sky anchor 2501 takes a form of rotary dynamic sail, as described above. Imaginary axis of this rotary dynamic sail is inclined in the direction of the wind at 60 degrees to the horizontal plane. Wind pressure on it creates pull in cable 2502, directed upward. Other details of construction and operation are similar to those, described for FIG. 25 and FIG. 26.

### Embodiments AG

### With Surrogate Axle

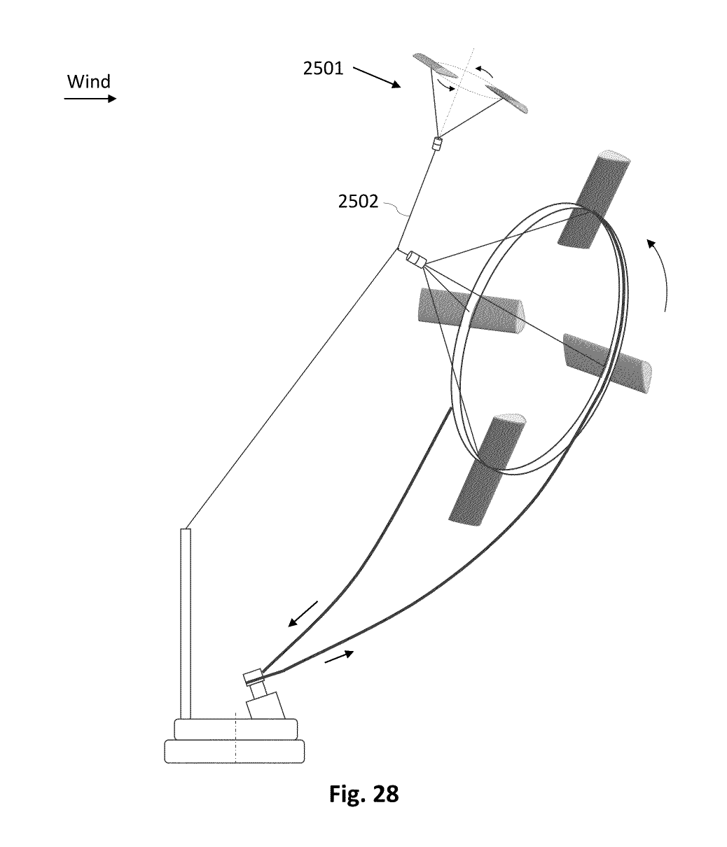

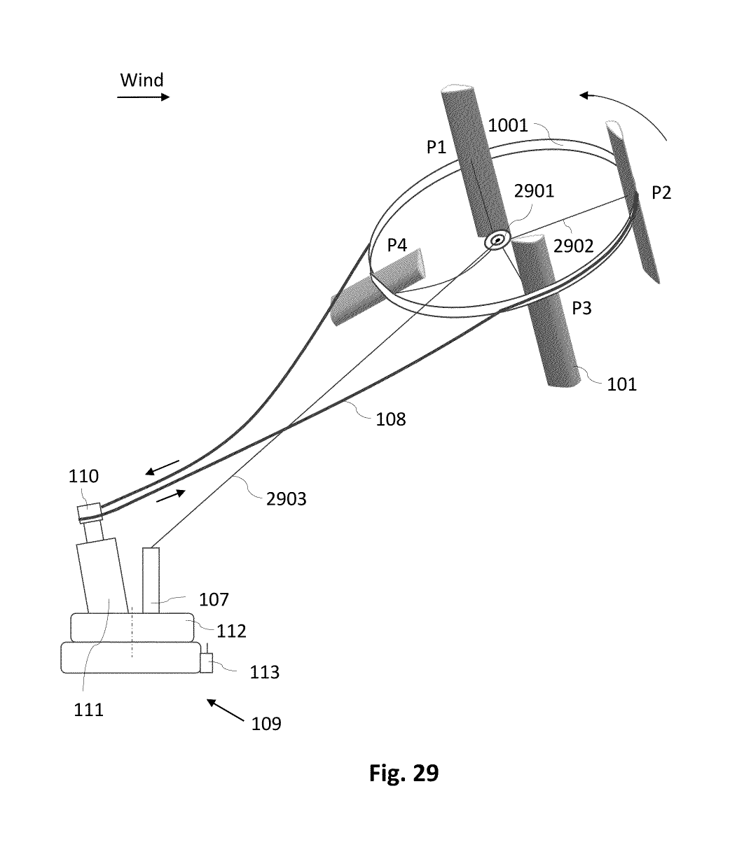

FIG. 29 shows another system, similar to one in FIG. 17. In addition, it comprises a disc 2901. Disc 2901 has an internal part and an external part, freely rotating around the internal part on ball bearings. Cables 2902 attach wings 101 to the external part of disc 2901. One cable is shown per wing, but multiple cables can be used to spread tension over the surface of the wing. Ground platform is similar to one in FIGS. 25 and 26. A tether 2903 is attached to ground anchor 107 with one end and to the center of the internal part of disc 2901 above ribbon 1001 with another end.

As ribbon 1001 rotates, the wing, entering upwind section of trajectory (wing in the position P4), quickly rolls, achieving position with its lateral axis almost parallel to tether 2903, and passes below it. Then, it rolls in the opposing direction and achieves its normal orientation perpendicular to the plane of motion (wing in the position P3). An alternative maneuver is for cables 2902 to pass through the wing. The devices, allowing to accomplish that, are well known (such devices were used to prevent mechanical sweeping of naval mines by letting a sweeping line to pass through a mooring line in WWII). In this embodiment, tether 2903 resists most of the wind pressure, acting on the airborne part of the system. Belt 108 experiences only force, necessary to provide friction or teeth engagement with pulley 108 and ribbon 1001. This allows to make it thinner and lighter. Disc 2901 can be replaced by an axle with length, exceeding wing span, and tether 2903 attached at the opposite ends of the axle. Use of ribbon 1001 can be replaced by use of traction devices 104, with small changes.

In one variant of this system, the lateral axis of the wing is perpendicular to the plane of rotation, except when the wing performs rolling maneuver, described above. The angle of attack is 3° for a nominal wind case. The wing is cambered; the angles vary, depending on strength of wind.

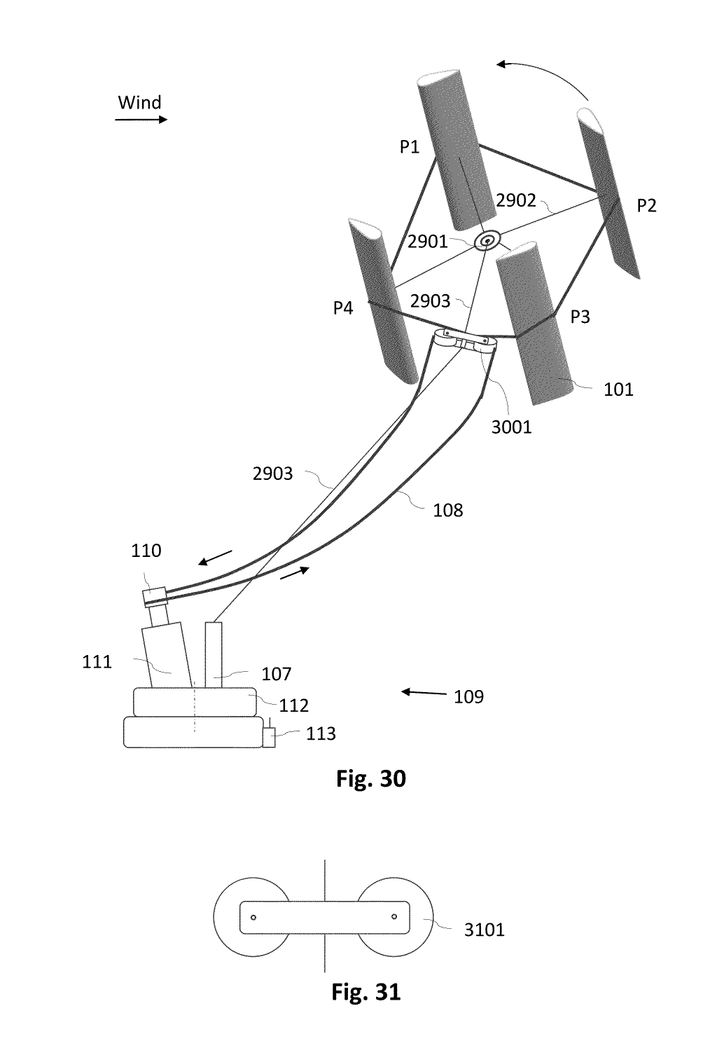

FIG. 30 shows another variation of the system in FIG. 29. One difference is that wing 101 in it has non cambered profile. In addition, it comprises a double pulley 3001. Double pulley 3001 consists of two pulleys 3101, joined together at some distance one from another, as shown in FIG. 31. Diameter of pulleys 3101 should be at least two times larger, than diameter of pulley 110 in order to avoid unnecessary back bending of belt 108.

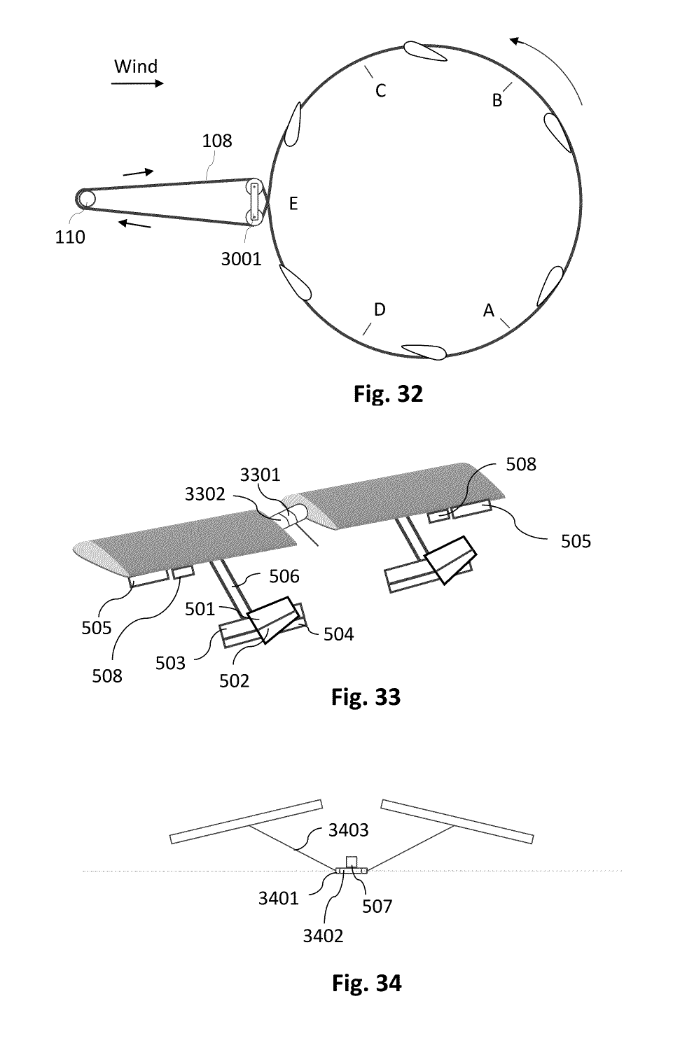

FIG. 32 shows schematic view of the parts of this system (with six wings) in the plane of rotation, from the top. It clearly shows, how belt 108 crosses itself in the point E. If we select a point on belt 108 and follow it from pulley 110, we will see how it travels in the air from pulley 110 to the first pulley of double pulley 3001, wraps around it for about 90 degrees, enters approximately circular motion counterclockwise in the point E, makes full circle, arrives to the second pulley of double pulley 3001, wraps around it for about 90 degrees and descends to its starting position. If we follow wing 101, we will see that it makes a full circle, and at the point E crosses from the inbound side of belt 108 to outbound side (inbound—moving toward pulley 110, outbound—moving in opposite direction). To perform this move, the traction device of the wing attaches itself to the second side of belt 108, which moves parallel to the first side and with the same speed, simultaneously detaching itself from the first side. In this system, wing 101 should be equipped with a device, allowing cable 2903 to pass through it. Plane of rotation in this embodiment can be also turned on the side, like in FIG. 22.

In one variant of this system, the lateral axis of the wing is perpendicular to the plane of rotation. The angle of attack is plus or minus 8°, depending on the position. The lift force is directed towards the center of the circle in 60° sector around point E, and outwards in the rest of the circle. The wing is non-cambered; the angles may vary, depending on strength of wind.

FIG. 33 shows a form of wing 101, suitable for use in this system. It is similar to the form on FIG. 20A, except that there is a narrow ring 3301 in the middle of the wing, freely rotating around an axle 3302. A cable can be attached to this axle and the wing can rotate full 360 degrees around its lateral axis (pitch) without hitting the cable. More than one such ring-axle construction can be used in one wing, allowing connecting suspension cables, thus spreading forces across the length of the wing. In many cases, 360 degrees of rotation are not required, only 180-210 degrees. In such variations a full opening is not required; just a section in the front end of the wing is enough and radius of ring 3301 can be equal to radius of curvature of the front part of the wing profile.

FIG. 34 shows another form of wing 101, suitable for use in certain embodiments of this invention, described here. It comprises an axle 3402 and rotating rings 3401 on this axle, and two wings, shown in FIG. 33, attached by cable 3403 to rings 3401. Shared control subsystem 507 is attached to axle 3402. Any cable, ribbon or belt, required by various variations of the system, interacts with axle 3402. This configuration allows better flexibility in the wings motion and better distribution of tension forces over the lifting surface.

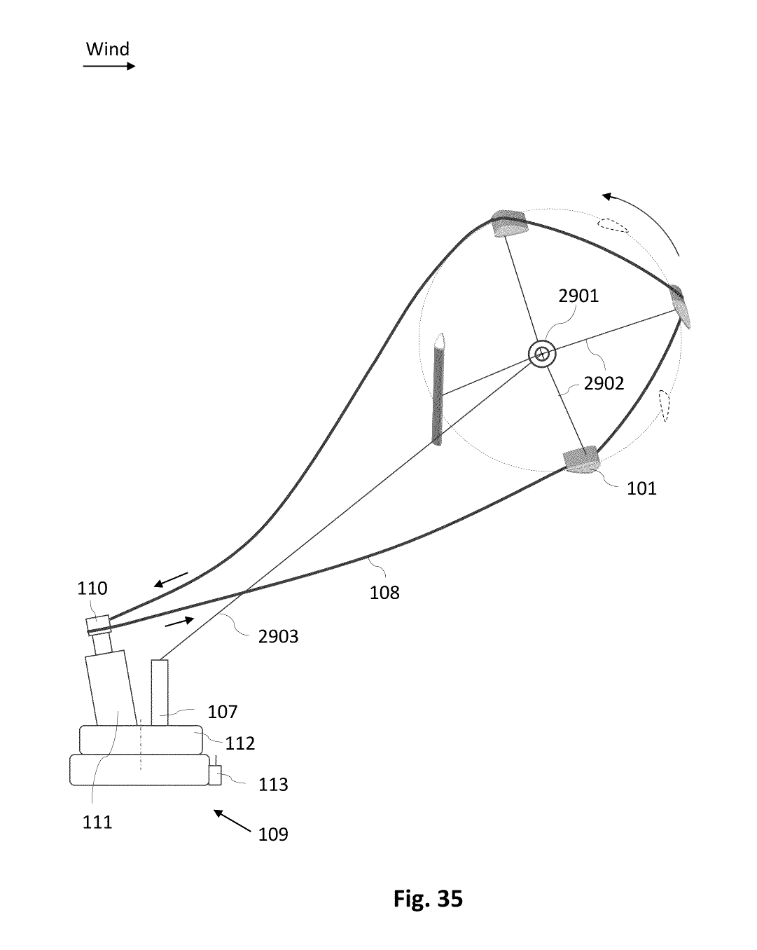

FIG. 35 shows another system that can be described as a cross between one in FIG. 29 and one in FIG. 1. The wings move in vertical circle around disk 2901, that is held by tether 2903. The forces, acting on wings, are similar to those in FIG. 18. The speed of wings is significantly higher than the speed of the wind. The aerodynamic lift, generated by moving wing 101 in the top and the bottom sectors of the circle (sectors DA and BC in FIG. 18) is used to shape belt 108 to a form, allowing wing 101 to move cross wind in sector AB. Wing 101 moves cross wind and generates most of the power in sector AB. Wing 101 rolls and/or yaws in sector CD to avoid tether 2903. Wing 101 is equipped with traction devices, that attaches it to belt 108 in the point D and detach it in the point C. Wing forms from FIGS. 20A, 20B and 21 can be used here.

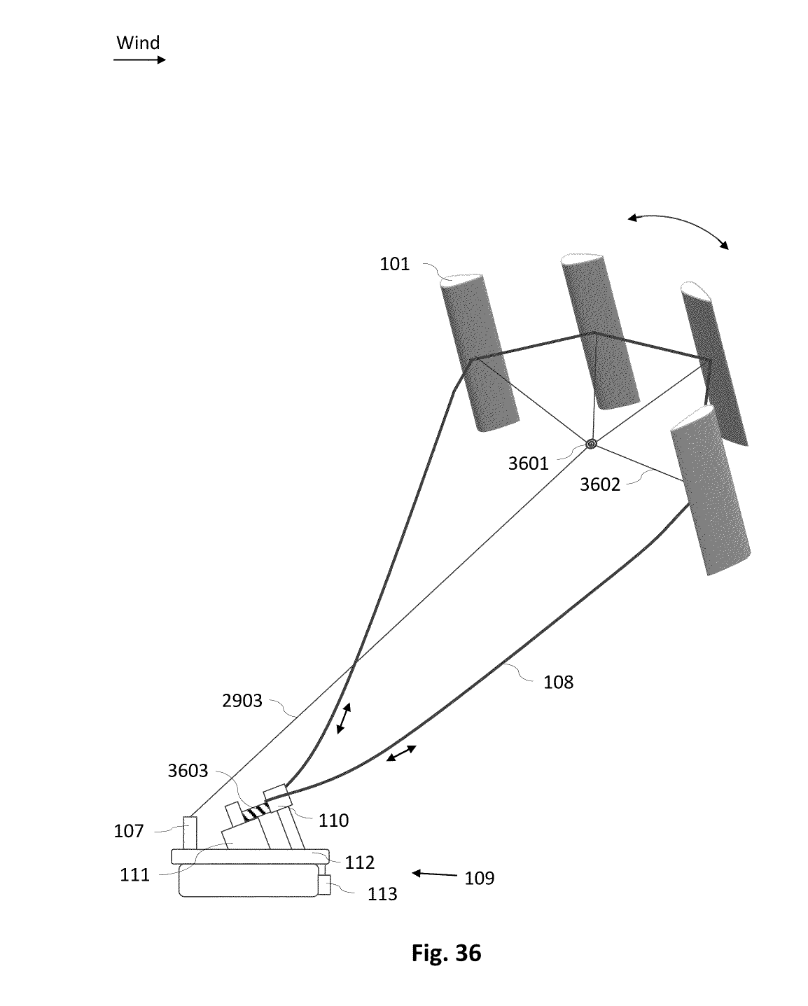

FIG. 36 shows an embodiment with reciprocal belt motion. It comprises a ground station 109, comprising control system 113 and rotating platform 112, holding electric generator 111, pulley 110, rotationally connected to the rotor of generator 111 via a mechanical transmission 3603, having a reverse gear. Also, ground anchor 107 is installed on platform 112. Tether 2903 is attached to ground anchor 107 by one end. Three or more wings 101 are placed in the air and move in the air under influence of aerodynamic forces. Each wing 101 is attached to the upper end of tether 2903 by a cable 3602. Upper end of tether 2903 will be called a center 3601. Each wing is permanently attached to belt 108, that wraps around pulley 110 in ground station 109. In this embodiment, belt 108 moves reciprocally, first counter clockwise, then clockwise. The reverse gear in transmission 3603 converts this reciprocal rotational motion into plain rotation of the rotor of generator 111. Thus, the working phase consists of two phases: counter-clockwise motion and clockwise motion of belt 108.

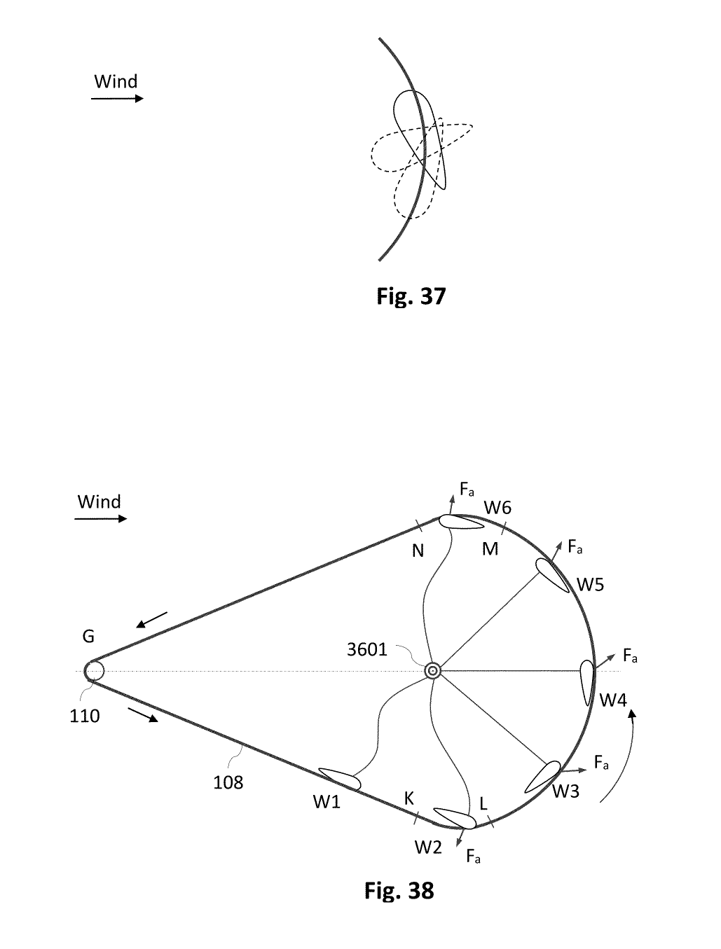

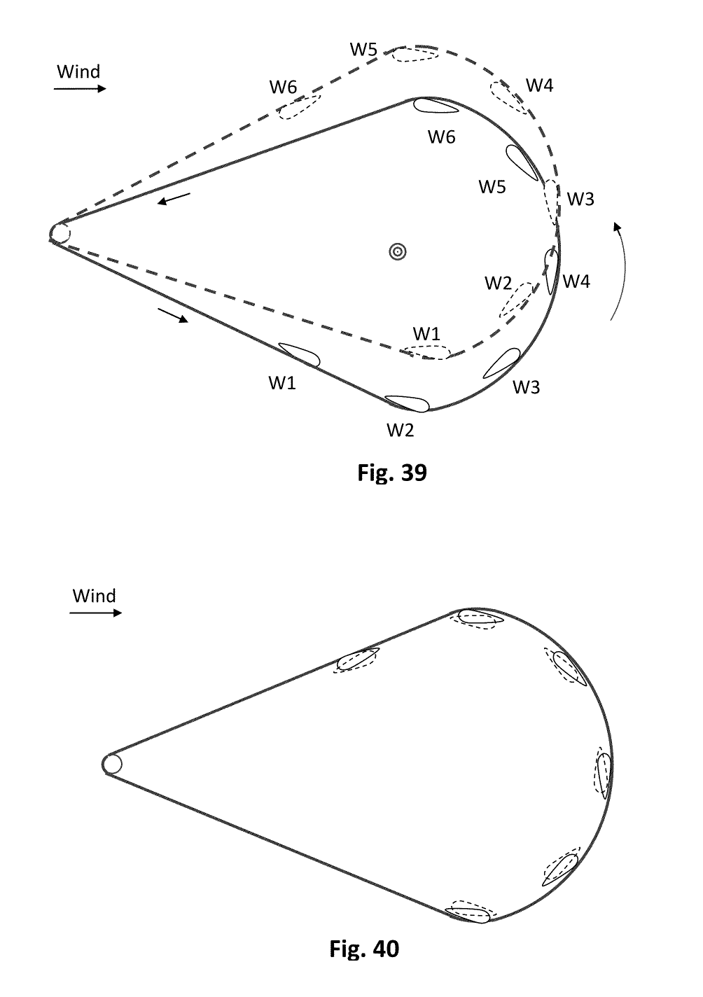

FIG. 38 shows schematically some details of this embodiment in the plane of motion of the centers of wings 101. In this variation of the embodiment, there are 6 non cambered wings W1-W6, and the system is shown in the beginning of the counter-clockwise phase. Letter G denotes pulley 110 in ground station 109. Direction of aerodynamic forces Fₐ, acting on the wings, are shown on the figure by arrows. Belt 108 can be logically divided into 5 sections. Sections NG and GK are straight (in this view). Wing W1 is attached to belt 108 in section GK. Its cable 3602 is not fully stretched. It is oriented with 0 angle of attack to the air flow (or turned with its side into the wind) and has only small drag force acting on it. Section LM is energy harvesting section. Wings W3, W4 and W5 are moving in it in circle, their cables are fully stretched, they absorb energy of wind and transfer it to belt 108, which transfers it to pulley 110 an ultimately to the rotor of generator 111. It is easy to see that projection of aerodynamic forces Fₐ on the tangent to the belt at the points of connection of these wings is in the direction of the motion. Sections KL and MN are transitional. Wings W2 and W6 in these sections use aerodynamic forces to push belt 108 sideways, preventing collapse of its form toward the centerline (dash-dotted line on the figure). Some energy, harvested in section LM, is spent on belt spreading in sections KL and MN. While belt 108 is moving, angles of attack of wings W1-W6 are being changed by the control system in order to prevent sideways motion of the whole construction (sideways—relative to central line), or at least to minimize such motion. Thus, angle of attack of wing W2 is larger, than of wing W6. By the end of the counter-clockwise phase, the wings 101 and belt 108 have moved counter-clockwise 45° around center 3601, as shown in FIG. 39. Then, all wings 101 pitch simultaneously, turning around 180 degrees, as shown in FIG. 40, and the clockwise phase starts. Clockwise motion happens symmetrically relative to centerline. Pitching motion is shown in more details in FIG. 37. Energy is produced in both clockwise and counter-clockwise phases.

In one specific variation of the embodiment, tether 2903 has angle 30° to a horizontal plane, length of tether 2903 is 3,000 meters, length of cable 3602 is 1,000 meters (same for each wing), wingspan is 100 meters. Belt 108 moves along its length for 800 meters in each direction. Wings 101 can be cambered, instead of non-cambered, with their upper side outwards, of course. Cambered wings are more efficient, but they cannot reverse their direction by pitching; they must yaw. When wings are yawing, belt 108 moves perpendicularly to the normal plane of motion for the time of yawing. Also, the wings may be reversible and exchange their leading and trailing edges when switching phases. Tether 2903 and cables 3602 can be omitted, but then belt 108 would have to carry full pressure of the wind. Wing 101 can be attached to cable 3602 on suspension cables.

This embodiment can be modified in view of embodiments, described above. For example, plane of wings motion can be rotated around the centerline, or the wings can move within a sphere, rather than in plane, or axial rotor can be imitated. Some of these embodiments allow wings to be safely attached to belt 108 for all time, while keeping benefits of previously described embodiments.

In the systems above, a chain or a perforated belt and a sprocket can be used as belt 108 and pulley 110. In this case, ribbon 1001 or 1701 would have protrusions, corresponding to the teeth of sprocket. A perforated flat belt may have an additional advantage that its motion will create turbulence around it and it will experience less aerodynamic pressure and will be less susceptible to oscillations. If a low friction cable or belt is used for belt 108, it can wrapping around pulley 110 more than 360 degrees.

Some of the systems, described above with traction device 104 can be used with ribbon 1001 or 1701, and vice versa, with small changes. Many variations in this description allow attaching wings by means of suspension cables, spreading load over the surface of the wing. Additional tightening pulleys and guiding pulleys can be used in ground station implementations to prevent belt slippage and ensure that belt arrives to pulley 110 at right angle. Most systems, described above, can change altitude at which wings operate by changing angle, at which airborne construction is attached to ground anchor 107, thus seeking the best wind conditions.

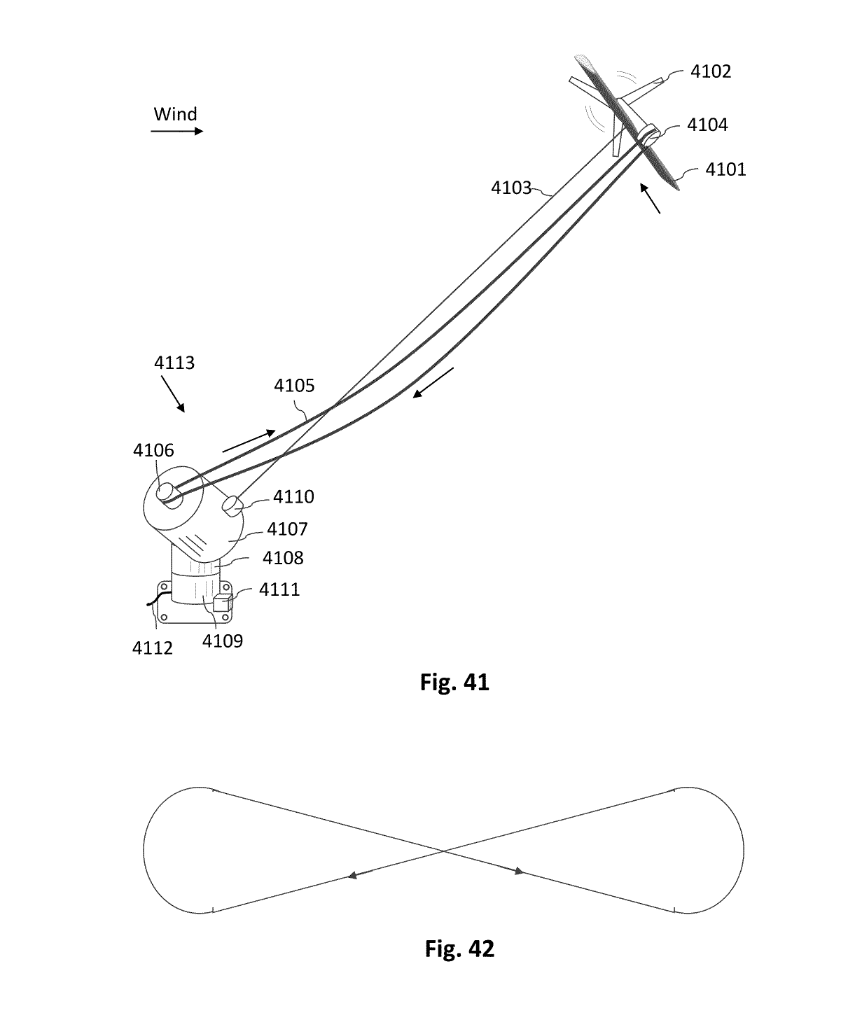

FIG. 41 shows a general view of another important embodiment of the invention. A wing 4101 is placed in the air and is flying cross wind with a speed, exceeding speed of the wind. Preferably, wing 4101 has a high L/D ratio, and its speed is 5-20 times higher, than the speed of the wind. A propeller 4102 is attached to the wing and is rotated by the oncoming air flow. Wing 4101 is tethered to the ground or to a ground station by a tether 4103. A pulley 4104 is coaxial to propeller 4102 and is rotated by it with high angular speed. A ground station 4113 is provided on the ground or slightly above the ground. It comprises a pulley 4106 and a generator 4107. Pulley 4106 is rotationally connected to the rotor of generator 4107 and can be co-axial with it. An endless (closed loop) belt 4105 connects pulley 4104 and pulley 4106, transferring rotation of propeller 4102 to the rotor of generator 4107 on the ground. Generator 4107 can be installed on top of a yawing system 4108, rotating in the horizontal plane on a fixed platform 4109 to follow shifts of wind and movement of wing 4101. Tether 4103 can be attached to ground station 4113 with a linear actuating device 4110, that slightly changes free length of cable 4103 depending on wear of belt 4105 and weather conditions. In constant wind, belt wear and humidity the length of cable 4103 stays constant. Tether 4103 preferably lies between sides of belt 4105, allowing wing 4101 to make left and right U-turns alternatively, without fouling belt 4105 and tether 4103. Generator 4107 is connected to energy consumers by an electric cable 4112. A control system 4111 can be a part of ground station 4113 or can be separate from it. Ground station 4113 can have a housing around generator 4107 and pulley 4106, which is not shown on the picture to avoid clutter.

In most implementations of this embodiment, tether 4103 has larger tension, than any side of belt 4105, and experiences less gravitational drop. In some variations, cable 4103 can be omitted, and belt 4105 will hold wing 4101 attached to pulley 4106 ground station 4113. Pulley 4104 and pulley 4106 have guards, preventing belt 4105 from falling off pulleys when wing 4101 changes speed and/or direction, which are not shown on the picture. Also, pulley 4104 and/or pulley 4106 can have belt guiding rollers, ensuring that belt 4105 hugs pulley 4104 correctly. Also, the rollers can be used to increase friction between the belt and the pulley by increasing the surface, in which the belt touches the pulley, and by pressing the belt against the pulley. Tension of belt 4105 is regulated by changing of length of tether 4103. The tension should be sufficient for current friction to prevent belt slippage. Also, a perforated belt and a toothed sprocket can be used. Imaginary line ground station—wing can have angle 35 degrees to horizon, or anywhere from 10 to 60 degrees. Tether 4103 can be made of an aerodynamic cable, described in PCT/US12/67143 by the author.

Control system 4111 comprises a central processor or a microcontroller, optional sensors and communication means for communication with optional control system 307 on the wing. Preferable communication means is a wireless network, although a cooper or optical cable, passing through tether 4103 can be utilized, too. The ground sensors may include anemometer, barometer, radar, hygrometer, thermometer, GPS, belt tension meter, RPM meter, cameras for observing the wings and other. One control system 4111 can serve multiple ground stations. The control system 4111 can be connected to the Internet to receive general weather information, especially warnings of extreme weather events. The wings 4101 can be any of the following: a rigid wing, like planes or gliders have; a flexible wing; a soft wing; an inflatable wing; an inflatable wing, inflated by the ram air, entering it through holes; a kite wing; a parafoil; a wing, using soft materials, spread over a rigid frame or cables; a wing made of elastic fabric, receiving airfoil form from relative air flow; a mixed wing, using different construction techniques in different parts of the wing; other types of wings. Wing 4101 can be made of various materials, including carbon fiber, fiberglass, wood, aluminum, aramids, para-aramids, polyester, high or ultra high molecular weight polyethylene and other. Wing 4101 can have various planforms; a wing, tapering to the ends in chord or thickness or both can be used (rectangular planform is shown on the drawings for clarity purposes only). Wing 4101 may have wingtips to decrease turbulence and noise. Belt 4105 can be flat, round, toothed, ribbed, grooved, perforated or V-belt. Other belt types can be used, too. A rope or a cable can be used as a belt. Preferably, material of surface of belt 4105 should have high friction or engagement with material of surface of pulley 4104 and pulley 4106.

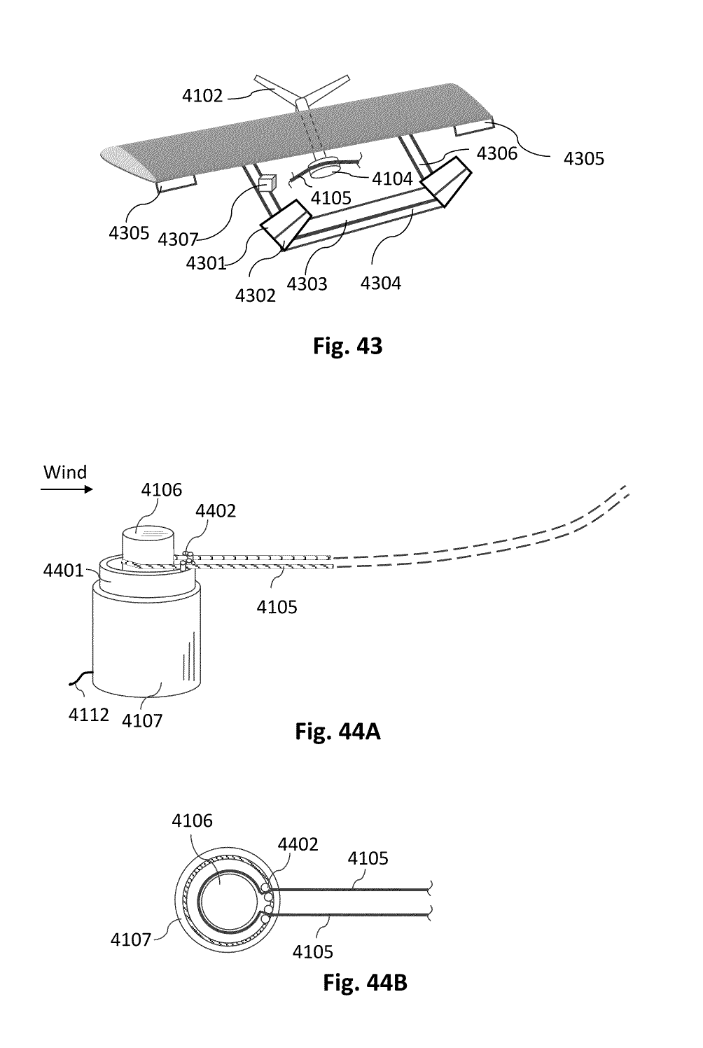

FIG. 43 shows the control system and control surfaces of wing 4101. The control surfaces comprise vertical stabilizers 4301, rudders 4302, a horizontal stabilizer 4303, an elevator 4304, and ailerons 4305. The control surfaces 4301-4304 are installed on the end of a double boom 4306 and can be combined between them in various combinations (like in stabilators, V-tails etc.). Attached to wing 4101 can also be a wing control system 4307. Control system 4307 comprises a central processor or a microcontroller, sensors and actuators for the rudders, the elevator and the ailerons, communication means for communication with the ground, and an energy source. The wing sensors may include speed meter, altimeter, accelerometer, gyroscopic sensor, GPS, stall warning device, compass, cameras and other. The energy source can be a battery or a small turbine, working from the air flow. Other types of wings and control elements are possible.

FIG. 42 shows desirable trajectory of movement of wing 4101 in the air, when viewed from ground station 4113. “Desirable” means that control system 4111 will try to steer wing 4101 along this trajectory, but real trajectory will differ. This trajectory is called “FIG. 8” and is known quite well in the existing art.

Flying cross wind, a wing with sufficient L/D ratio can achieve speed of 40-200 m/s. This is also the speed of the relative air flow against the wing. Relatively small and inexpensive propeller 4102 is rotated by incoming air flow with high RPM, and transfers its rotational energy to a ground generator via belt 4105. Depending on the ratio of diameters of pulley 4104 and pulley 4106, angular velocity of pulley 4106 can be higher or lower, than angular velocity of pulley 4104.

Belt 4103 can move with high speed, such as 50-150 m/s. Because of the high speed, its tension is relatively, thus allowing for thinner and lighter belt.

In the absence of wind wing 4101 can be still kept airborne. To achieve this, generator 4107 works as a motor, rotating pulley 4106 in the opposite direction. Belt 4105 transfers rotation to propeller 4102, which provides forward speed to wing 4101. Movement of wing 4101 keeps it airborne. Thus, there is no need to bring wing 4101 down, except for maintenance and in rare cases of extreme weather.

This embodiment should be compared to two types of airborne wind energy devices, that resemble it most:

1) devices with airborne generator
2) devices with the ground based generator and a power transmitting tether

Compared with devices with airborne generator, this embodiment has advantage that the wing does not need to carry heavy generator and other energy converting equipment. Also, it does not have to transmit electrical energy through a conducting tether.

Compared with devices with ground based generator and power transmitting tether, this embodiment has advantage of higher RPM and, consequently, lower forces, acting on the pulley in the ground station. Thus, it does not require a gearbox, or require only an inexpensive gearbox with low ratio. Also, it does not require a drum with winding/unwinding cable, and it produces energy constantly, rather than intermittently.

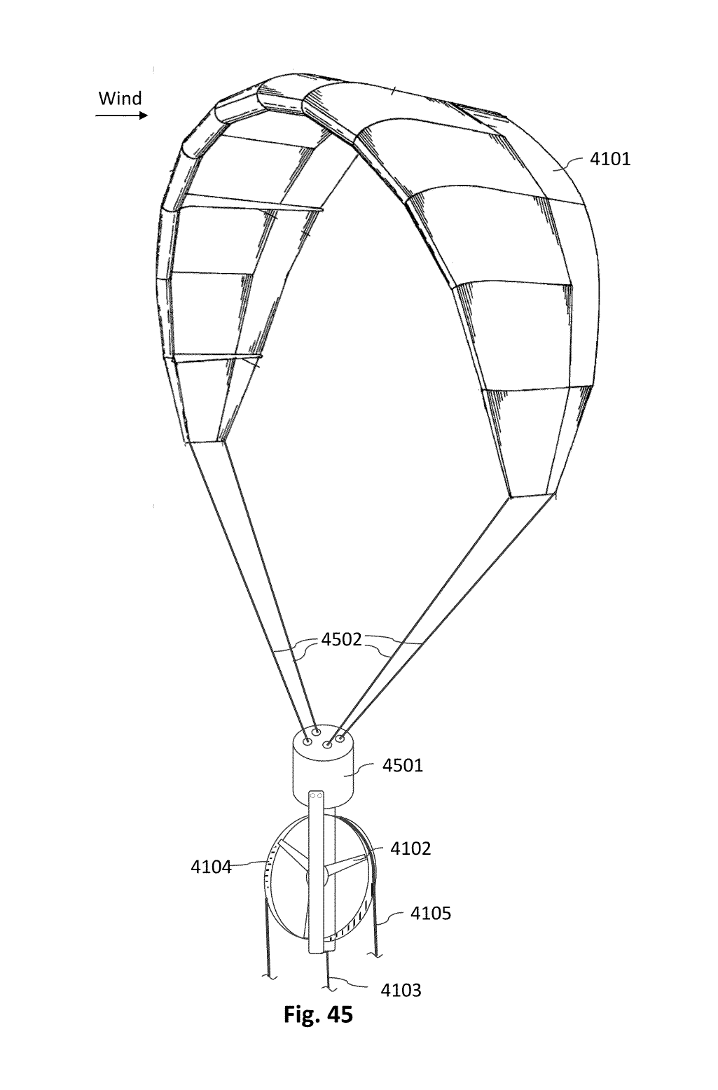

FIG. 44A and FIG. 44B show possible details of the ground station in this embodiment. FIG. 44A is a perspective view, while FIG. 44B is a top view. In this variation, pulley 4106 and generator 4107 have vertical axis and are installed without the yawing system. A small ring 4401 can rotate on bearings around pulley 4106. A belt guiding system 4402 is installed on ring 4401. Belt guiding system 4402 can comprise horizontal and vertical rollers. Belt guiding system ensures that belt 4105 hugs pulley 4106 correctly, i.e. with its flat side and perpendicular to pulley axis. It is easy to achieve because of high length of the belt and significant drop, which decreases the belt's angle to horizon near ground station 4113. Guiding system 4402 rotates on ring 4401, following changes in the direction of cable 4105. Horizontal rollers can be close to pulley 4106, and press belt to 4105 against it, thus increasing friction or tooth/hole engagement.

FIG. 45 shows general view of another variation of this embodiment, in which wing 4101 is a parafoil. It comprises four combined control and suspension cables 4502 and a control device 4501. In this form, position of the wing relative to the wind and to the horizon is controlled by control device 4501 dynamically changing the lengths of cables 4502. Propeller 4102 is attached below control device 4501. FIG. 45 shows also another aspect of the invention—pulley 4104 integrated with a shroud of propeller 4102. Other parts of this embodiment are similar to those in FIG. 41. There may be an empennage with vertical stabilizer, attached to control device 4501.

The embodiments, described above, were described in conjunction with land location. Nevertheless, they can be practiced in sea, ocean, lake or other marine location. When located in a water body, the ground station can be deployed on columns or on a floating structure, anchored to the bottom. The tethers can be attached to similar columns or structures, or directly to the bottom, or to floating buoys, anchored to the bottom. In yet another embodiment, the ground station is installed on a ship, and generates power for it. In a variation of this embodiment, belt 4105 can be used to rotate the ship's propeller through a mechanical transmission, rather than using electrical generator and electrical energy as an intermediary. Further, in any place, where an electrical generator is mentioned, another power conversion device can be used. Some of the power conversion devices are: a) an air compressor, producing compressed air and/or heat for industrial processes, energy storage or another use; b) a water pump, pumping water for an energy storage, irrigation or another use.

Additional enabling details of the construction and operation of various embodiments of this invention can be found in the referenced disclosures. Additional embodiments of the invention can be obtained by combining teaching from the text and drawings here, and the referenced disclosures.

Thus, airborne wind energy conversion systems with endless belt and related systems and methods are described in conjunction with specific embodiments. While above description contains many specificities, these should not be construed as limitations on the scope, but rather as exemplification of several embodiments thereof. Many other variations are possible.

What is claimed is:

1. A wind energy conversion system, comprising:
at least one airborne wing, adapted to harvest wind power while flying mostly cross wind;
an upper rotational member, attached to the airborne wing;
an electrical generator on the ground;
a lower rotational member on the ground, rotationally coupled to the rotor of the electrical generator;
an endless belt, rotationally connecting the upper and the lower rotational members.

2. The system of claim 1, further comprising an electronic control system adapted to control flight of the wing.

3. The system of claim 1, further comprising a tether, attaching the airborne wing to the ground.

4. The system of claim 1, wherein the airborne wing carries at least one propeller, rotationally coupled to the airborne rotational member.

5. The system of claim 1, wherein the wing is rigid and comprises at least two control surfaces.

6. The system of claim 1, wherein the wing is flexible and its form is changed by two or more lines.

7. The system of claim 1, wherein the wing speed exceeds the wind speed.

8. The system of claim 1, wherein the endless belt is perforated and the upper and lower rotational members have teeth, matching the belt perforations.

9. A method of generating power from wind, comprising steps:
providing an airborne wing having an airfoil cross section;
providing an electrical generator on the ground;
capturing wind energy with an airborne wing controlled to move mostly cross wind faster than wind; and
transferring the captured wind energy from the airborne wing to the electrical generator on the ground by mechanical motion of an endless belt.

10. The method of claim 9, further comprising steps of:
using at least one propeller on the airborne wing, rotating by incoming airflow;
converting rotation of the propeller into motion of the endless belt.
